(19) United States
(12) Patent Application Publication
(10) Pub. No.: US 2013/0054294 A1
(43) Pub. Date: Feb. 28, 2013

(54) SALES PRODUCTIVITY SYSTEM

(71) Applicants: Ken Vuylsteke, Chagrin Falls, OH (US); Ken Werbeach, Wickliffe, OH (US); Richard Stolzman, Defiance, MO (US)

(72) Inventors: Ken Vuylsteke, Chagrin Falls, OH (US); Ken Werbeach, Wickliffe, OH (US); Richard Stolzman, Defiance, MO (US)

(73) Assignee: THE TRANZONIC COMPANIES, Cleveland, OH (US)

(21) Appl. No.: 13/600,820

(22) Filed: Aug. 31, 2012

Related U.S. Application Data
(60) Provisional application No. 61/529,650, filed on Aug. 31, 2011.

(51) Int. Cl. G06Q 10/10

(52) U.S. Cl. 705/7.18

(57) ABSTRACT

A Sales Productivity System (SPS) allows a distributed sales force to access sales-related data through a common application or interface. Each member of the sales force uses the application to organize and manage a sales schedule for a given territory, and to maximize their time on the sales field.

### RELATED APPLICATION

The present application is being filed as a U.S. non-provisional patent application claiming priority/benefit under 35 U.S.C. §119(e) from the U.S. provisional patent application having Ser. No. 61/529,650 and filed on Aug. 31, 2011, the entire disclosure of which is incorporated herein by reference.

### FIELD

The general inventive concepts relate, among other things, to systems, methods, and apparatuses for managing a distributed sales force.

### BACKGROUND

Sales professionals have historically relied on paper-based organizing tools such as planners and calendars to organize their sales schedules, as well as face-to-face meetings, emails and telephone calls. While paper-based planners have existed for some time, advances in technology, particularly portable computing technology, create an opportune situation for utilizing technology to provide sales professionals with tools incapable of being effectively delivered though paper-based means.

Portable computing devices have been widely adopted in the technology-driven modern world. “Smart” phones (e.g., Apple's iPhone®, Google's Droid®, Research in Motion's Blackberry® and the like) are one class of portable computing devices which combine the functionality of Personal Digital Assistants (“PDAs”) with the functionality of cellular or mobile phones. Like laptops before them, tablet computers (mobile computer/tablet/portable computer) (e.g., Apple's iPad®, Samsung's Galaxy®, Motorola's XOOM® and the like) are another class of portable computing devices which have gained popularity in recent years. Along with the advent and widespread acceptance of the smartphones and tablet computers came the use of applications (“apps”). Apps are software/programs that operate on smartphones and tablet computers to perform specific functions desired by the consumer.

In the context of the modern sales professionals, mobile phones and tablet computers are ubiquitous tools in their sales toolkit. However, even though mobile phones and tablet computers are now equipped to host and process complex apps that perform a wide variety of functions for the consumer, relatively few specialized apps have been developed to meet the needs of sales professionals. Therefore, there is a need for enhancing mobile/portable technology by providing a dynamic app which provides sales professionals with the tools to effectively fashion sophisticated sales plans, manage complex business relationships, and achieve measurable results.

### SUMMARY

The general inventive concepts contemplate systems, methods, and apparatuses for implementing and utilizing a mobile sales application (herein referred to as a “Sales Productivity System (SPS) Application” or “SPS Application”). The SPS Application provides a collection of sales management tools.

By way of example, to illustrate various aspects of the general inventive concepts, several exemplary embodiments of an SPS Application (including related systems, methods, and apparatuses) are disclosed herein.

In one exemplary embodiment, a system (e.g., a sales productivity system) is disclosed. The system includes a server; a data store interfaced with the server; a network; and a mobile client device for accessing the server over the network, wherein a user associated with a sales territory uses the mobile client device to decompose or otherwise divide the sales territory into a plurality of sales zones, wherein each of the sales zones is associated with at least one customer, said customer being a current customer or a prospective customer within the sales territory, wherein each of the sales zones is associated with a different calendar day in a sales cycle, and wherein the user uses the mobile client device to schedule an activity with each customer in each sales zone on its associated calendar day.

In one exemplary embodiment, the user uses the mobile client device to assign a potential value to each customer, and the potential value is used to determine an amount of time that the user will devote to selling to the customer. In one exemplary embodiment, a first potential value is assigned if the customer has at least one of 100+ employees and $15,000+ annual gross-profit-after-freight potential, a second potential value is assigned if the customer has at least one of 50-99 employees and $7,500-$14,850 annual gross-profit-after-freight potential, a third potential value is assigned if the customer has at least one of 25-49 employees and $3,750-$7,350 annual gross-profit-after-freight potential, and a fourth potential value is assigned if the customer has at least one of 10-24 employees and $1,500-$3,600 annual gross-profit-after-freight potential.

In one exemplary embodiment, the user uses the mobile client device to assign a probability value to each customer, said probability value indicating a likelihood of success with the customer. In one exemplary embodiment, a first probability value is assigned if a 90%+ account penetration is expected, a second probability value is assigned if a 50%+ account penetration is expected, a third probability value is assigned if a 25%+ account penetration is expected, and a fourth probability value is assigned if a 10%+ account penetration is expected.

In one exemplary embodiment, the user uses the mobile client device to access information relating to each customer in the sales territory. In one exemplary embodiment, the user uses the mobile client device to access information relating to each customer associated with one of the sales zones. In one exemplary embodiment, the user uses the mobile client device to access information relating to a specific customer.

In one exemplary embodiment, the user uses the mobile client device to establish a new customer in the system, said new customer being a new current customer or a new prospective customer, and the new customer is associated with one of the sales zones.

In one exemplary embodiment, the user uses the mobile client device to place an order for an item by a customer.

In one exemplary embodiment, the user uses the mobile device to initiate synchronization between data stored on the mobile device and data stored in the data store. In one exemplary embodiment, data stored in the mobile device is synchronized with data stored in the data store according to a set schedule. In one exemplary embodiment, data stored in the mobile device is synchronized with data stored in the data store periodically. In one exemplary embodiment, the data stored in the mobile device is synchronized with the data stored in the data store every thirty minutes.

In one exemplary embodiment, the network is the Internet.

In one exemplary embodiment, the mobile client device communicates with the network over a cellular communications network.

In one exemplary embodiment, if communications between the mobile client device and the server are interrupted, data requests from the mobile client device to the server are placed in a queue maintained within the mobile client device until the interruption is resolved.

In one exemplary embodiment, the user uses the mobile client device to communicate with the server to request a report, the server uses data stored in the data store to generate the report, and the server sends the report in an email to the mobile client device.

In one exemplary embodiment, the activity is a visit to a facility of the customer within the sales zone associated with the customer. In one exemplary embodiment, the user uses the mobile client device to activate a navigation function, said navigation function providing driving directions to the facility.

In one exemplary embodiment, the user uses the mobile client device to select one or more customers in the same sales zone to be visited on the same calendar day, and the system calculates a sequence for visiting the customers based on an optimal driving route.

In one exemplary embodiment, the activity is one of a telephone call and an email.

In one exemplary embodiment, the client mobile device displays a calendar with information on each sales zone and the related customers and activities indicated on the corresponding days of the sales cycle.

In one exemplary embodiment, the mobile client device is a tablet computer.

In one exemplary embodiment, the sales cycle is twenty days.

In one exemplary embodiment, a system (e.g., a sales productivity system) is disclosed. The system includes a server; a data store interfaced with the server; a network; a mobile client device for accessing the server over the network; and an application installed on the mobile client device, said application operable to: decompose a sales territory into a plurality of sales zones; associate each of the sales zones with at least one customer, said customer being a current customer or a prospective customer within the sales territory; associate each of the sales zones with a different calendar day in a sales cycle; and associate an activity with each customer in each of the sales zones on its associated calendar day.

In one exemplary embodiment, said application implements a plurality of modules selected from the group comprising: a customers module, a zone setup module, a zone schedule module, a daily sales plan module, an open orders module, a sales history module, an item history module, a past due invoices module, a close activity module, a cloning module, a sync module, a library module, a reports module, and a trade agreements module.

In one exemplary embodiment, said application implements a customers module, a zone setup module, a zone schedule module, a daily sales plan module, an open orders module, a price book module, a sales history module, an item history module, a past due invoices module, a close activity module, a cloning module, a sync module, a library module, a reports module, and a trade agreements module.

In addition to the exemplary embodiments present herein, the general inventive concepts encompass other related systems, methods, and apparatuses. Furthermore, numerous aspects of the general inventive concepts will become readily apparent from the following detailed description of exemplary embodiments, from the claims and from the accompanying drawings.

### BRIEF DESCRIPTION OF THE DRAWINGS

The general inventive concepts as well as embodiments and advantages thereof are described below in greater detail, by way of example, with reference to the drawings in which:

FIG. 1 is a diagram illustrating a sales productivity system, according to one exemplary embodiment.

FIG. 2 is a diagram illustrating a request-response model, according to one exemplary embodiment, for use in the system of FIG. 1.

FIG. 3 is a flowchart illustrating a method of processing requests, according to one exemplary embodiment, within the system of FIG. 1.

FIG. 4 is a flowchart illustrating a method of synchronizing data, according to one exemplary embodiment, within the system of FIG. 1.

FIG. 5 is a flowchart illustrating a method of controlling access, according to one exemplary embodiment, for use in the system of FIG. 1.

FIG. 6 is a diagram illustrating a menu, according to one exemplary embodiment, for accessing different modules in a sales productivity system, such as the system of FIG. 1.

FIG. 7 is an image showing an instance of the menu of FIG. 6.

FIG. 8 is a flowchart illustrating a method of managing customer information, according to one exemplary embodiment, within the system of FIG. 1.

FIG. 9 is an image showing a view of customer information for a customer, according to one exemplary embodiment.

FIG. 10 is a flowchart illustrating a method of placing orders, according to one exemplary embodiment, within the system of FIG. 1.

FIG. 11 is a flowchart illustrating a method of managing a sales territory, according to one exemplary embodiment, within the system of FIG. 1.

FIG. 12 is an image showing a sales territory, according to one exemplary embodiment, decomposed into multiple zones.

FIG. 13 is a flowchart illustrating a method of managing sales zones, according to one exemplary embodiment, within the system of FIG. 1.

FIG. 14 is a flowchart illustrating a method of scheduling visits to sales zones, according to one exemplary embodiment, within the system of FIG. 1.

FIG. 15 is a flowchart illustrating a method of managing daily sales activities, according to one exemplary embodiment, within the system of FIG. 1.

FIG. 16 is a flowchart illustrating a method of managing daily sales activities, according to one exemplary embodiment, within the system of FIG. 1.

FIG. 17 is a flowchart illustrating a method of managing pending orders, according to one exemplary embodiment, within the system of FIG. 1.

FIG. 18 is a flowchart illustrating a method of tracking sales performance, according to one exemplary embodiment, within the system of FIG. 1.

FIG. 19 is a flowchart illustrating a method of managing historical sales information, according to one exemplary embodiment, within the system of FIG. 1.

FIG. 20 is a flowchart illustrating a method of managing past due activities, according to one exemplary embodiment, within the system of FIG. 1.

FIG. 21 is a flowchart illustrating a method of managing past due invoices, according to one exemplary embodiment, within the system of FIG. 1.

FIG. 22 is a flowchart illustrating a method of impersonating another user, according to one exemplary embodiment, within the system of FIG. 1.

FIG. 23 is a flowchart illustrating a method of generating reports, according to one exemplary embodiment, within the system of FIG. 1.

FIG. 24 is a flowchart illustrating a method of managing trade agreements, according to one exemplary embodiment, within the system of FIG. 1.

FIG. 25 is a flowchart illustrating a method of performing daily manager review, according to one exemplary embodiment, within the system of FIG. 1.

### DETAILED DESCRIPTION

While the general inventive concepts are susceptible of embodiment in many different forms, there are shown in the drawings and will be described herein in detail specific embodiments thereof with the understanding that the present disclosure is to be considered as merely an exemplification of the principles of the general inventive concepts. Accordingly, the general inventive concepts are not intended to be limited to the specific embodiments illustrated herein.

Unless otherwise defined, all technical and scientific terms used herein have the same meaning as commonly understood by one of ordinary skill in the art to which these embodiments belong. The terminology used in the description herein is for describing particular embodiments only and is not intended to be limiting of the embodiments. As used in the specification, the singular forms “a,” “an,” and “the” are intended to include the plural forms as well, unless the context clearly indicates otherwise. Any publications, patent applications, patents, and other references mentioned herein are incorporated by reference in their entirety.

The following are definitions of exemplary terms used throughout the disclosure. Both singular and plural forms of all terms fall within each meaning^{.}

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, functions, modules, or programs including separate applications or code from dynamically linked libraries. Software may also be implemented in various forms such as a stand-alone program, a function call, a servlet, an applet, instructions stored in a memory, part of an operating system, or other type of executable instructions. It will be appreciated by one of ordinary skill in the art that the form of software is dependent on many diverse factors such as, for example, the requirements of a desired application, the environment it runs on, and/or the desires of a designer/programmer or the like.

“Mobile application” or “mobile app” or “app” as used herein, includes, but is not limited to, software that runs on mobile devices such as smartphones, tablet computers, and the like. In some embodiments, “mobile application,” “mobile app,” and “app” may be used interchangeably with “SPS Application.” Mobile applications sometimes allow users to connect to services which were traditionally available only on desktop or notebook platforms, but can now be accessed by smaller, more readily portable devices such as smartphones, tablet computers, and other mobile devices. Some mobile applications are written purely for usage on such mobile devices and may not have desktop or notebook counterparts. Like traditional desktop and/or notebook services, these mobile applications often support interfacing with a communications network, such as the Internet, an intranet, a cellular network, or a wireless fidelity (Wi-Fi) network, to access, retrieve, transmit, and share data.

“Computer” or “processing unit” as used herein includes, but is not limited to, any programmed or programmable electronic device that can store, retrieve, and process data. This includes, but is not limited to, desktop computers and notebook computers, as well as mobile devices such as tablet computers, mobile phones, and smartphones.

A “territory” as used herein is defined as a particular geographic area.

A “user” may be used interchangeably with a “sales professional.” The term “user” encompasses not just a sales professional; however, but also includes any other person or persons using the SPS Application.

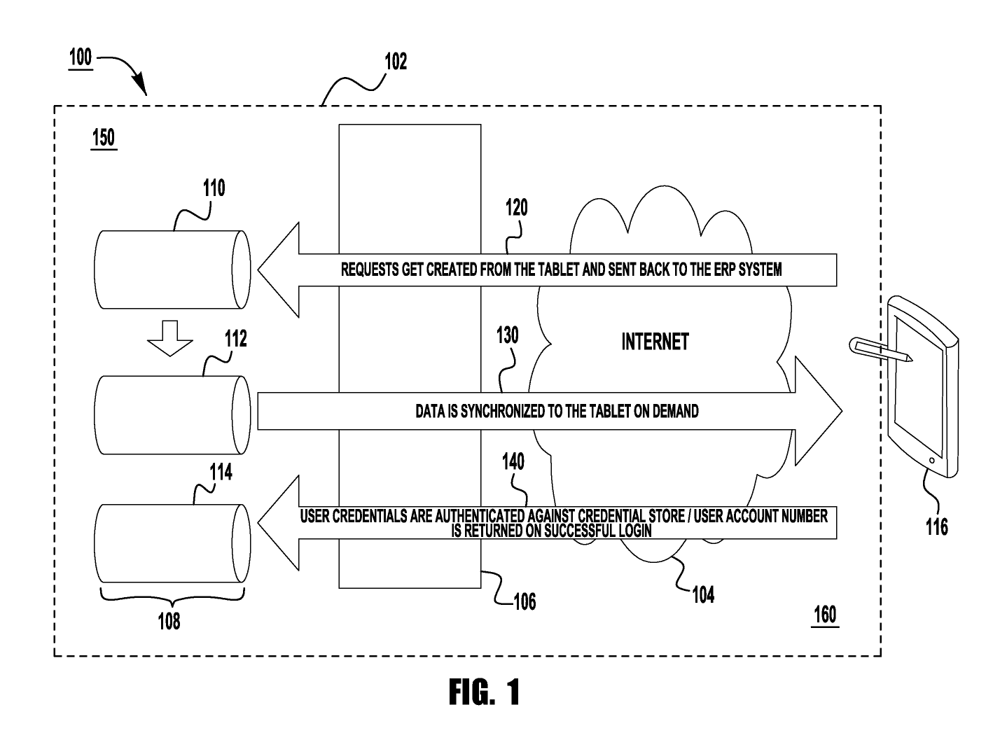

A Sales Productivity System (SPS) Application, according to one exemplary embodiment, will be described with reference to FIGS. 1-25. The SPS Application is an exemplary embodiment of software implementing various aspects of the general inventive concepts described herein. For example, the SPS Application allows a sales professional, other user, such as a manager, or a business organization to organize and manage a sales schedule and to maximize the user's time in the sales field. The SPS Application can be used in the sale of any types or categories of products. The SPS Application has been used, for example, in the sales of paper products, bathroom accessories and public restroom products, but can be used to sell and manage the sales of any types of products.

The SPS Application functions within a system 100 that includes hardware and any additional software related thereto which constitutes the system infrastructure 102. In one exemplary embodiment, the system infrastructure 102 includes a communications network 104, a web server 106, and one or more data stores 108 (see FIG. 1). In one exemplary embodiment, the communications network 104 is the Internet.

The web server 106 is one or more computers running a web server application. In one exemplary embodiment, the web server application is Microsoft's Windows Server® 2008 R2 including Microsoft's Internet Information Services (IIS) 7.5. In one exemplary embodiment, the server-side functionality of the system 100 is further shaped, for example, using Microsoft's ASP.NET MVC framework.

The system 100 stores data in the one or more data stores 108. In one exemplary embodiment, the data is maintained across multiple physical or logical databases. For example, the web server 106 can interface with an enterprise resource planning (ERP) database 110 to implement an ERP system that integrates internal and external management information across the entire organization. In one exemplary embodiment, Microsoft's Dynamics AX 4.0 is used to implement the ERP system. In one exemplary embodiment, the ERP database 110 is managed using Microsoft's SQL Server® 2008 R2.

In one exemplary embodiment, the data stores 108 include a staging database 112 that acts as an intermediary storage area to provide continuous access to the data. The staging database 112 allows access to the data to continue even when data is being imported from various external sources. As a result, interruptions and downtime are reduced when data is refreshing or being loaded during processing. In one exemplary embodiment, the staging database 110 is managed using Microsoft's SQL Server® 2008 R2.

In one exemplary embodiment, the data stores 108 include a credential store database 114 that acts as a central location for network administration and security. The credential store database 114 is used to authenticate and authorize users and/or computers within the system 100. In one exemplary embodiment, the credential store database 114 is implemented using Microsoft's Active Directory (AD) directory service, which is included in Microsoft's Windows Server® 2008 R2.

The system infrastructure 102 of the system 100 allows any number of mobile devices 116, as client devices, to communicate with the web server 106 over the communications network 104 to access, retrieve, transmit, and/or share data (e.g., via the data stores 108). Thus, the system 100 encompasses a plurality of mobile devices 116. In one exemplary embodiment, the mobile device 116 is a tablet computer. In one exemplary embodiment, every member of a sales force is assigned a mobile device 116 (e.g., a tablet) and is set up as an authorized user of the system 100. In one exemplary embodiment, the mobile device 116 communicates with the communication network 104 via a cellular network. In one exemplary embodiment, the mobile device 116 communicates with the communication network 104 via a Wi-Fi network.

Each mobile device 116 runs an instance of the SPS Application as a client application. In one exemplary embodiment, the SPS Application is written to run exclusively on mobile devices. In one exemplary embodiment, the SPS Application is provided to the mobile devices 116 according to an application service provider (ASP) model.

The mobile device 116 includes internal memory (not shown) for storing data locally. The SPS Application uses or otherwise includes database management software for managing the local data storage at the client. In one exemplary embodiment, the database management software is SQLite.

In one exemplary embodiment, the SPS Application is written to run on the Android® platform, which is an operating system for mobile devices such as mobile/smartphones and tablet computers. The Android® operating system was and continues to be developed by the Open Handset Alliance, led by Google, Inc. In one exemplary embodiment, the SPS Application is written using the Java® programming language. The SPS Application is hardware independent and can be installed and run on any device that runs a supported version (e.g., version 2.2) of the Android® operating system.

As described above, the system 100 implements a client-server configuration, wherein the system 100 defines a server side 150 and a client side 160. In one exemplary embodiment, the server side is centralized such that the system 100 includes a single web server or a collection of web servers at a single geographical location, with the client side consisting of a plurality (e.g., tens, hundreds, thousands) of distributed clients. In one exemplary embodiment, the server side is not centralized such that the system 100 includes multiple web servers situated at different geographical locations, with the client side consisting of a plurality (e.g., tens, hundreds, thousands) of distributed clients, such that the system 100 includes logic for directing requests from a particular client (e.g., mobile device 116) to a particular server (e.g., web server 106).

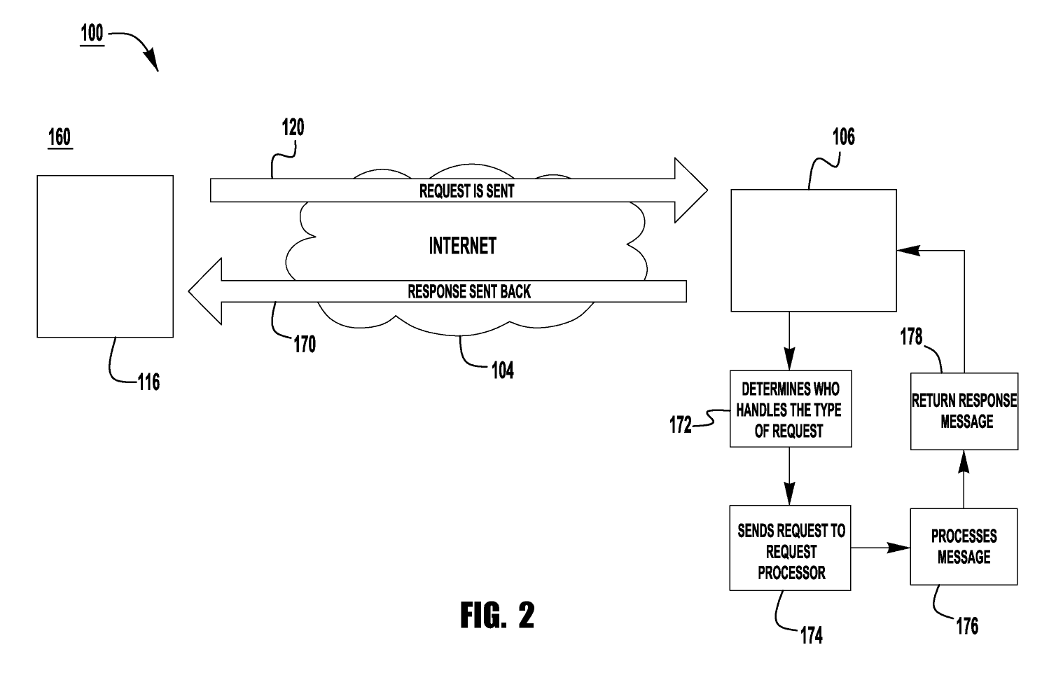

The system 100 allows a user to continue to function (i.e., perform sales-related tasks) even when the user's mobile device 116 lacks an active data connection (i.e., an active connection to the web server 106). All data requests (e.g., create new lead, create sales order, close out activity) generated by the user are stored locally and subsequently sent to the web server 106 (implementing the ERP system with the ERP database 110) during a synchronization process. The flow of data requests from the mobile device 116 to the ERP database 110 through the web server 106 is labeled 120 in FIGS. 1-2.

As shown in FIG. 2, when a data request is transmitted from the mobile device 116 to the web server 106, the web server 106 first determines which part of the system 100 handles the particular type of data request at 172. Then, at 174, the web server 106 sends the data request to the proper request processor based on this determination. The request processor then processes the data request at 176. Finally, the request processor generates a response message at 178. The flow of response messages from the web server 106 to the mobile device 116 is labeled 170 in FIG. 2.

If the mobile device 116 receives an acceptable response from the web server 106, it will process the response and remove the original request from its queue. If the web server 106 cannot be reached (e.g., because the mobile device 116 cannot find an active cellular signal; because the web server 106 suffers a power failure; because the web server 106 takes too long to respond, i.e., times out), or if the web server 106 responds with an invalid response, the request will simply stay in the queue of the mobile device 116. In this manner, transmission of the request will be attempted again during the next synchronization process. If there is an issue with the request, it is logged on the server side 150 so that an administrator can take appropriate actions to resolve the issue.

The data requests are structured in a manner that allows a child request to be dependent on a parent request, such that the child request is not sent to the web server 106 (implementing the ERP system with the ERP database 110) until the parent request is completed. For example, the user entering a lead causes a “Create Lead Request” to be placed in the Request Queue of the user's mobile device 116. Since the ERP system has not yet seen this request an appropriate identifier has not yet been generated, so the mobile device 116 generates a temporary Lead ID number for this lead. Because the system 100 identifies the request as having a temporary ID, any additional data requests that depend on the Lead Record, such as a “Create New Contact” or “Create New Activity” request, will be stored as a dependent request. Once the parent request has been completed (i.e., an appropriate Lead Identifier has been returned from the ERP system), the dependent data requests will be updated to use the ERP Lead ID and they will be available to be sent to the ERP system. The system 100 allows for a request to be dependent on any number of parent data requests. For example, a “Sales Order” request may be dependent on both a “Create Lead” request as well as a “Created Credit Card” request. The child request will not be available to be sent until all parent data requests have been completed.

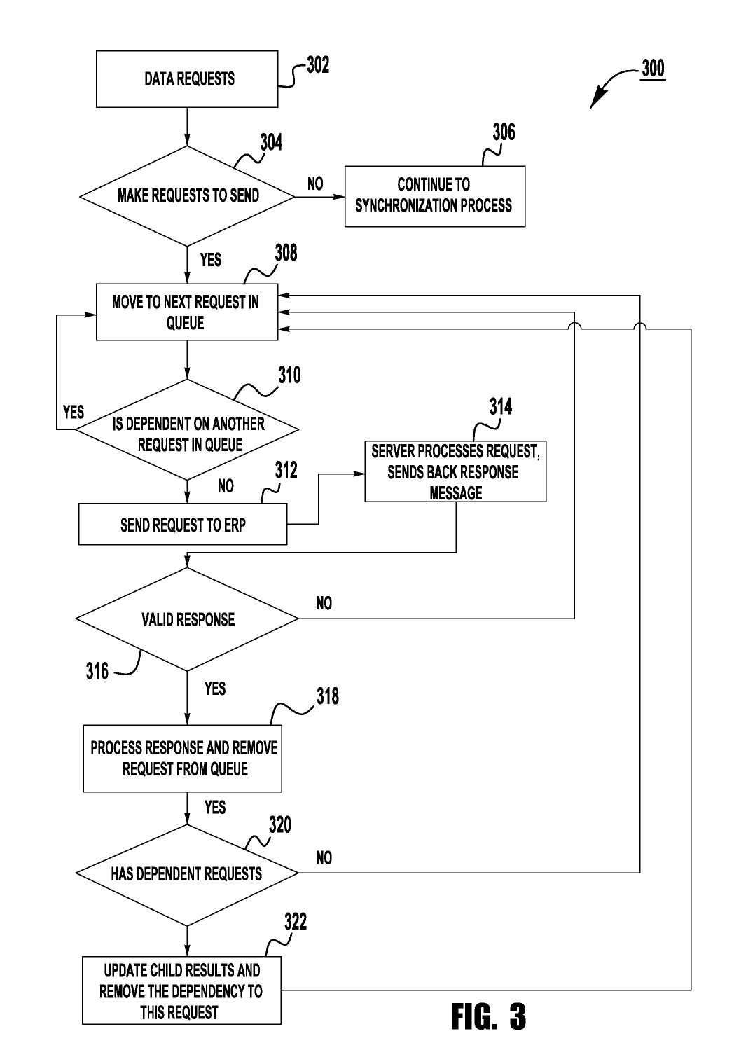

A method 300 of processing data requests (including dependent data requests), according to one exemplary embodiment, is shown in FIG. 3. In the method 300, data requests are generated at a user's mobile device (e.g., the mobile device 116) and placed in a queue for transmission to the ERP system (e.g., the ERP database 110 via the web server 106), in step 302. As an initial matter, it is determined in step 304 if there are any more data requests present in the queue to be transmitted. If not, the method 300 continues to a synchronization process in step 306. If there are data requests present in the queue, the next data request in the queue is taken up in step 308. The data request is evaluated in step 310 to determine if it is dependent on another data request in the queue. If the data request is dependent on another queued data request, processing returns to step 308 and the next data request in the queue is taken up (i.e., the data request having dependencies is bypassed at this time). If the data request is not dependent on another queued data request, the data request is sent to the ERP system in step 312. As a result, the ERP system processes the data request and sends back a response in step 314. In step 316, the response from the ERP system is evaluated to determine if it is valid. If the response from the ERP system is not valid, processing returns to step 308 and the next data request in the queue is taken up (i.e., the previously sent data request is bypassed at this time). If the response from the ERP system is valid, the response is processed and the data request is removed from the queue in step 318. Additionally, the data request is evaluated in step 320 to determine if there are any other data requests in the queue dependent on it. If not, processing returns to step 308 and the next data request in the queue is taken up. If it is determined that there are other data requests in the queue dependent on the data request being removed from the queue, those other data requests are updated in step 322 to remove their dependency on the data request being removed from the queue. Thereafter, processing returns to step 308 and the next data request in the queue is taken up.

In one exemplary embodiment, the SPS Application includes a software module or the like implementing the method 300, within the system 100.

In the system 100, the data is aggregated from different data stores (e.g., over a network) and stored in the staging database 112. The data is updated periodically, such as according to a set schedule. In one exemplary embodiment, the frequency of the updating is done according to a schedule implemented by Microsoft's SQL Server Integration Services (SSIS) package.

Each data record is marked with a last updated time and a deleted flag so that when a “synchronization” or “sync” command is received from the mobile device 116, the staging database 112 can send back any records that have been modified since the last time the mobile device 116 was synchronized and indicate whether the records should be deleted. The flow of data from the staging database 112 (e.g., via the web server 106) to the mobile device 116 is labeled 130 in FIG. 1.

The SSIS package compares the data from live data stores against the data in the staging database 112 and inserts records, updates records, and/or marks records as deleted in the staging database 112 to mirror the live data stores.

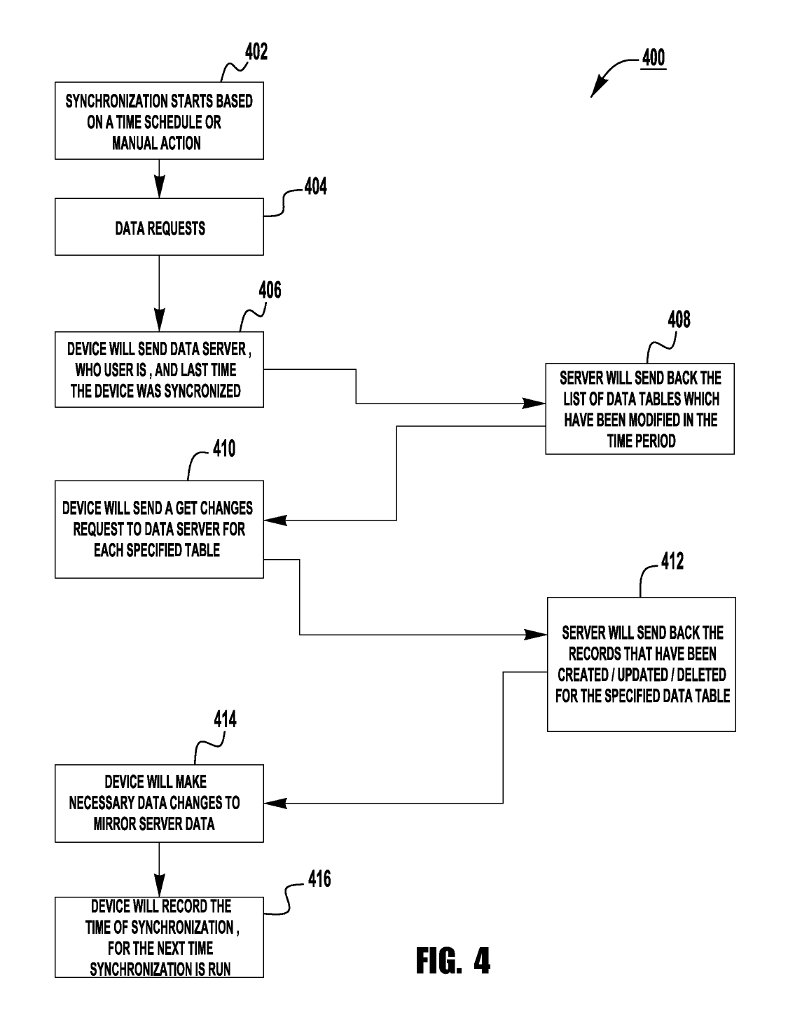

A method 400 of synchronizing data between the data stores 108 and the mobile device 116 (i.e., internal storage of the mobile device 116), according to one exemplary embodiment, is shown in FIG. 4. In the method 400, the synchronization processing is initiated either according to a set schedule as described above or in response to a “sync” command input by the user via the user's mobile device 116, in step 402. The web server 106 (acting as a Data Server managing the data stores 108) then generates data requests that are sent to the mobile device 116 in step 404. The mobile device 116 responds in step 406 with information identifying the user and the last time the mobile device 116 was synchronized. In step 408, the Data Server returns a list of data tables which have been modified in the period of time since the mobile device 116 was last synchronized. The mobile device 116 then sends a data request (i.e., a “get changes” request) to the Data Server for each specified table in step 410. In response to each such data request, the Data Server sends the records that have been created, updated, and/or deleted for the specified data table in step 412. Then, in step 414, the mobile device 116 makes the necessary changes in its local/internal storage so that its data mirrors the data on the Data Server. Finally, in step 416, the mobile device 116 records the time of the synchronization for use during the next instantiation of the synchronization method 400.

In one exemplary embodiment, the SPS Application includes a software module or the like implementing the method 400, within the system 100.

The SPS Application provides a collection of sales management tools which represent an advancement over conventional sales management platforms. By way of example, these tools may: foster increased sales productivity; facilitate organization of periodic (e.g., daily) sales functions; aid in the creation, implementation, and utilization of a sales schedule; assist in assessing performance; generate details reports for logging and tracking pertinent information; perform analytics on underlying sales data; promote consistency (e.g., more uniform implementation of “best practices”) across a distributed sales force; etc.

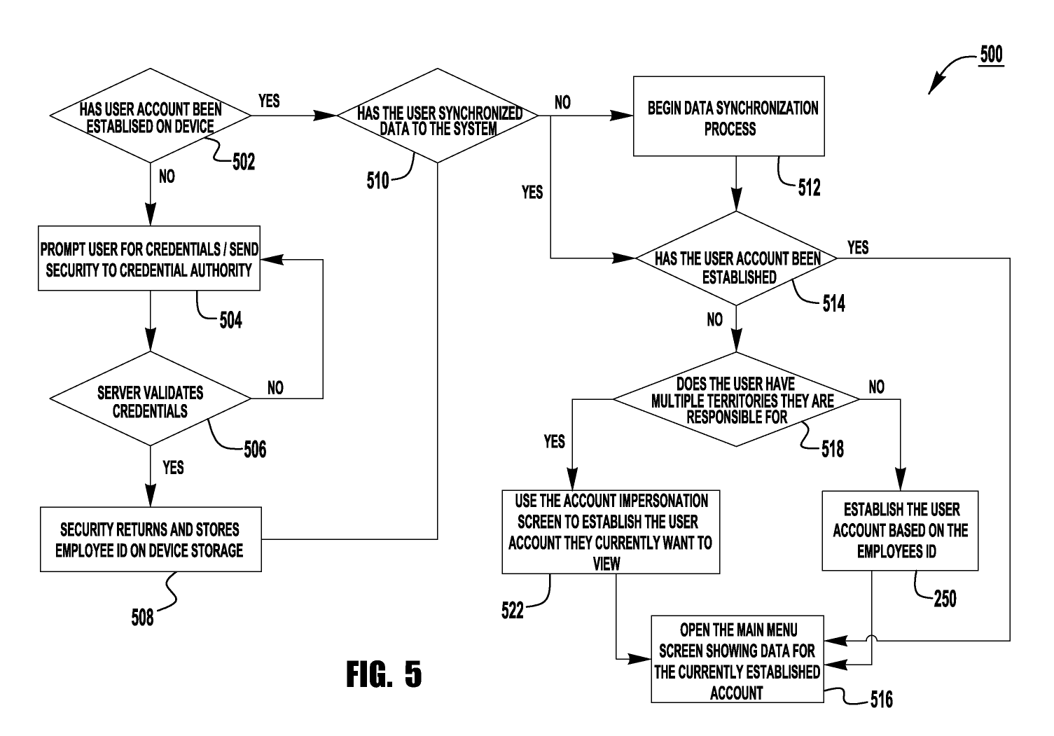

Access to the SPS Application is limited to authorized users of the system 100. A method 500 of authenticating a user of the system 100, according to one exemplary embodiment, is shown in FIG. 5.

In the method 500, an initial determination is made in step 502 as to whether a user account has been established on the mobile device 116. If a user account has not been established on the mobile device 116, the web server 106 (acting as a Credential Authority managing the credential store database 114) prompts the user for his credential information (e.g., username, password) in step 504. Once provided, the credential information is sent to the Credential Authority, also in step 504. The flow of data from the mobile device 116 to the credential store database 114 is labeled 140 in FIG. 1. The Credential Authority then attempts to validate the user's credential information in step 506. If the Credential Authority cannot validate the user's credential information, processing returns to step 504 where the Credential Authority again prompts the user for his credential information. If the Credential Authority successfully validates the user's credential information, the Credential Authority responds with security information which is stored on the user's mobile device 116 in step 508 to establish a user account on the mobile device 116.

Once a user account is established on the mobile device 116, the Credential Authority will not initially prompt the user for his credential information. Instead, the Credential Authority in step 510 determines whether the user has synchronized data to the system 100 (e.g., with the data stores 108). If the user has not synchronized data before, then the Credential Authority will initiate data synchronization in step 512. Once the synchronization process is complete, the Credential Authority confirms that a user account is established on the mobile device 116 in step 514. Similarly, if the user has synchronized data before, then processing skips right to step 514 with the Credential Authority confirming that a user account is established on the mobile device 116.

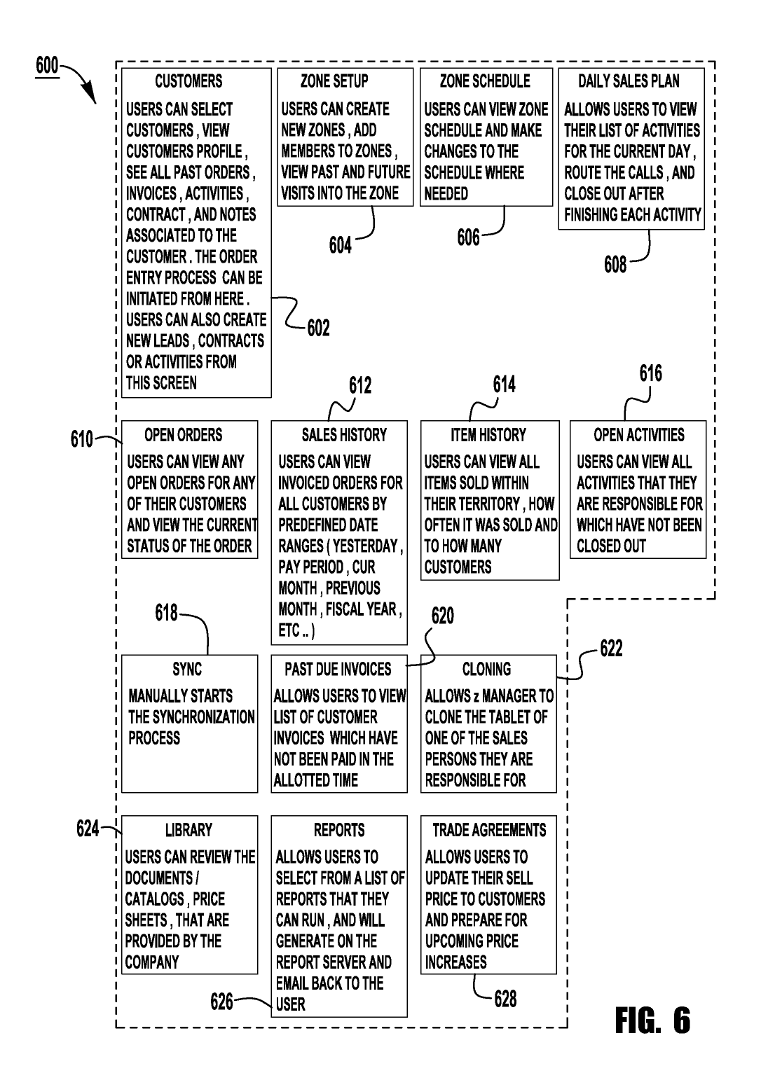

If the Credential Authority confirms that a user account is established on the mobile device 116, access to the system 100 is granted and the SPS Application displays a main menu (see FIG. 6) for accessing data associated with the user's currently established account, in step 516. Otherwise, if the Credential Authority fails to confirm that a user account is established on the mobile device 116, the Credential Authority determines in step 518 whether the user is responsible for multiple territories. If the user is not responsible for multiple territories, a user account is established on the mobile device 116 using information uniquely identifying the user (e.g., the user's employee ID number), in step 520. Thereafter, processing goes to step 516 wherein access to the system 100 is granted and the SPS Application displays the main menu for accessing data associated with the user's currently established account.

If the user is responsible for multiple territories, an Account Impersonation interface allows the user to select the particular user account they want to access, in step 522. Thereafter, processing goes to step 516 wherein access to the system 100 is granted and the SPS Application displays the main menu for accessing data associated with the particular user's currently established account.

In one exemplary embodiment, the SPS Application includes a software module or the like implementing the method 500, within the system 100.

A main menu 600 of the SPS Application, according to one exemplary embodiment, is shown in FIG. 6. In one exemplary embodiment, the main menu 600 is displayed to the user after the user succeeds in logging into the system 100 (using the SPS Application on the user's mobile device 116).

The main menu 600 grants access to various modules, functions, or the like of the SPS Application. The modules will often include their own interfaces each of which can be considered a sub-menu of the main menu 600. The main menu 600 includes means for accessing each sub-menu. The means for accessing can be implemented in any fashion, such as by use of selectable (e.g., clickable) links or buttons. In general, menu selections, module selections and other types of selections within the SPS Application may occur by touching the desired selection or by touching and holding the desired selection. A touch screen of the mobile device 116 can be used to implement such a touch-based interface. One of ordinary skill in the art will appreciate that other types of selection can be utilized in the SPS Application, as long as such selection types are supported by the underlying hosting platform hosting the SPS Application. As it relates to this application, the terms “choose” and “select”, or any variations thereof, may imply the selection of the particular item utilizing the touch and/or touch and hold selection mechanisms.

In one exemplary embodiment, the main menu 600 includes fourteen selectable icons for accessing one or more sub-menus corresponding to each icon. As shown in FIG. 6, the main menu 600 provides access to the following modules: a “customers” module 602, a “zone setup” module 604, a “zone schedule” module 606, a “daily sales plan” module 608, an “open orders” module 610, a “sales history” module 612, an “item history” module 614, an “open activities” module 616, a “sync” module 618, a “past due invoices” module 620 a “cloning” module 622, a “library” module 624, a “reports” module 626, and a “trade agreements” module 628.

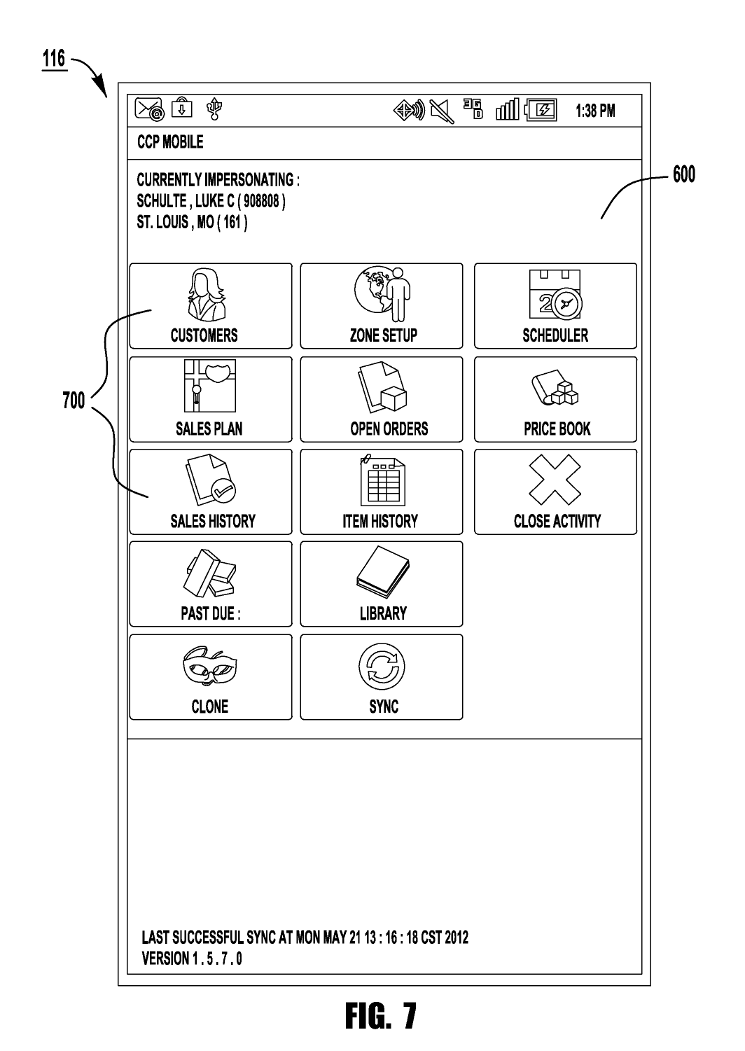

In one exemplary embodiment, the main menu 600 is dynamic and can display varying numbers of icons 700 depending on the current context of the SPS Application. Selecting any of the icons 700 launches a corresponding module, such that the main menu 600 is replaced with a sub-menu providing an interface for the user to interact with the module. A view of the main menu 600 and the icons 700, as displayed on the mobile device 116, is shown in FIG. 7.

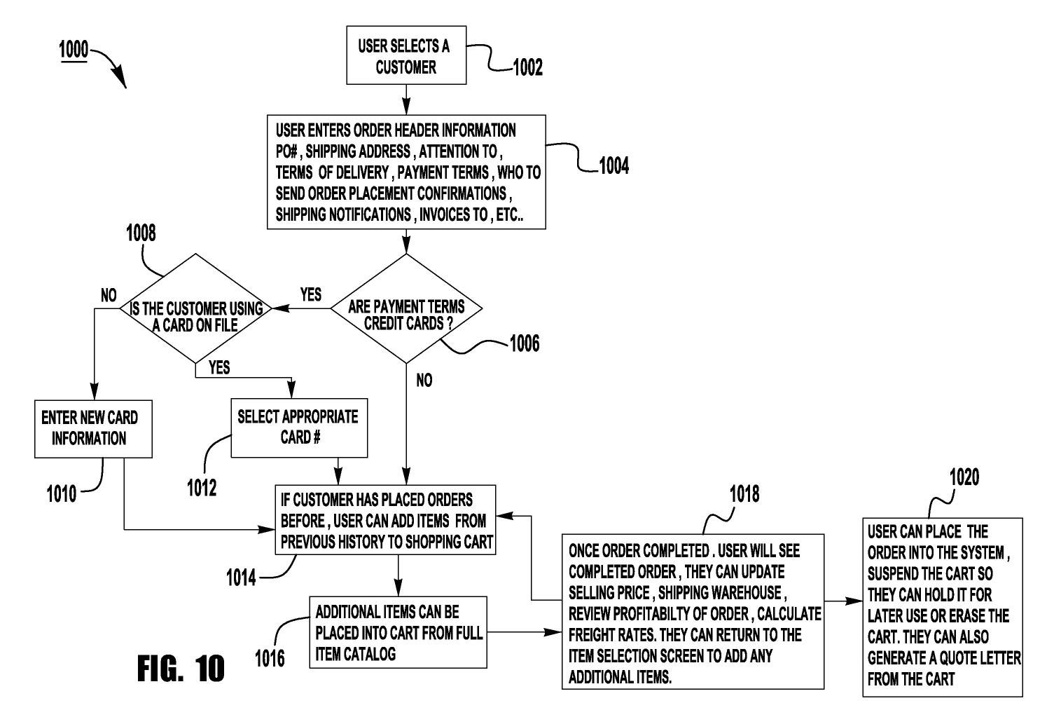

The customers module 602 provides an interface between the user's mobile device 116 (i.e., the SPS Application) and information on customers stored in the data stores 108 (e.g., the staging database 112). For example, the customers module 602 allows users to select customers, view profiles of those customers, and see past orders, invoices, activities, contacts, and notes associated with the customers. An order entry process (see FIG. 10) can be initiated from the customers module 602. The customers module 602 also allows users to create new leads (for prospective customers), contacts, and/or activities.

In one exemplary embodiment, leads information is obtained through any external means including, but not limited to, third-party customer information providers. The third-party information may be screened through various filters to yield ideal or optimized leads to target for sales activities. These filters may be based, for example, on geographic locations, proximity to other businesses or landmarks, the numbers of employees of the business, categories or types of businesses (for example, automotive related, hardware related, retail or big-box), etc. The lead filtering process can be implemented and run on servers 106, any other connected servers or computers, or by third-party customer information providers.

Thus, the customers module 602 represents an electronic account card of customers, wherein the user can interact with the customers module 602 to access information on customers, such as those customers in particular territory. The SPS Application allows the user to define different classes of customers, for example: active/buying, new, revived, close to inactive (e.g., no purchases in last 12 months), and inactive (no purchases in last 15 months), as well as leads. In one exemplary embodiment, the customer information is color-coded for display purposes to make it easier for the user to identify the classification of a particular user. In one exemplary embodiment, active/buying, new, and revived customers are assigned a first color (e.g., green), close to inactive customers are assigned a second color (e.g., yellow), inactive customers are assigned a third color (e.g., violet), and leads are assigned a fourth color (e.g., blue).

In one exemplary embodiment, the customers module 602 displays a list of all customers in the system (e.g., arranged alphabetically by customer name). In one exemplary embodiment, the customers module 602 allows the user to search and/or filter the list of customers being displayed. For example, the list of customers can be filtered based on the aforementioned customer classes. As another example, alphanumeric searching of the list of customers allows the user to readily locate a specific customer. In one exemplary embodiment, the customers module 602 allows the user to sort the list of customers being displayed. For example, the user could elect to sort the list of customers by customer name, city, or zip code.

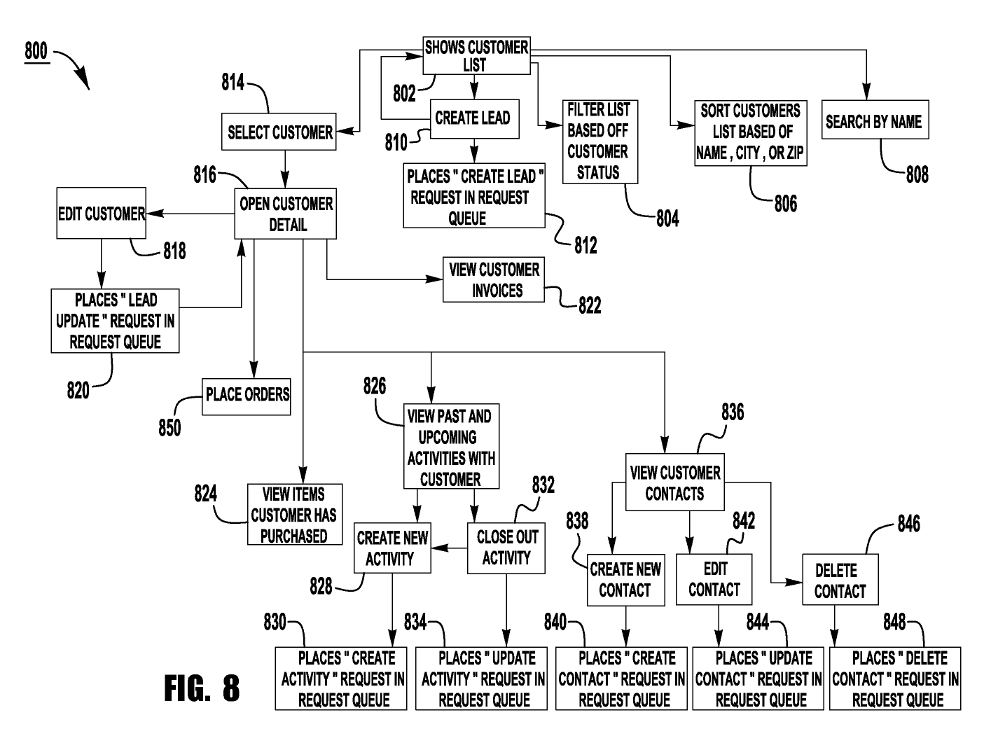

A method 800 implementing the customers module 602, according to one exemplary embodiment, is shown in FIG. 8. In the method 800, a default view listing all customers (only a portion of which may be visible on the screen at any given time) is displayed in step 802. Portions of the list which are not currently visible on the display of the mobile device 116 can be scrolled to or otherwise brought into view by interacting with the customers module 602.

From this default view listing all customers, the user can perform various customer-related functions. As noted above, the user can filter the list of customers (step 804), sort the list of customers (step 806), and/or search the list of customers of a particular customer or group of customers (step 808).

The user can also elect to create a lead in step 810. By selecting this feature, the SPS Application places a “create lead” request in the request queue maintained by the user's mobile device 116, in step 812.

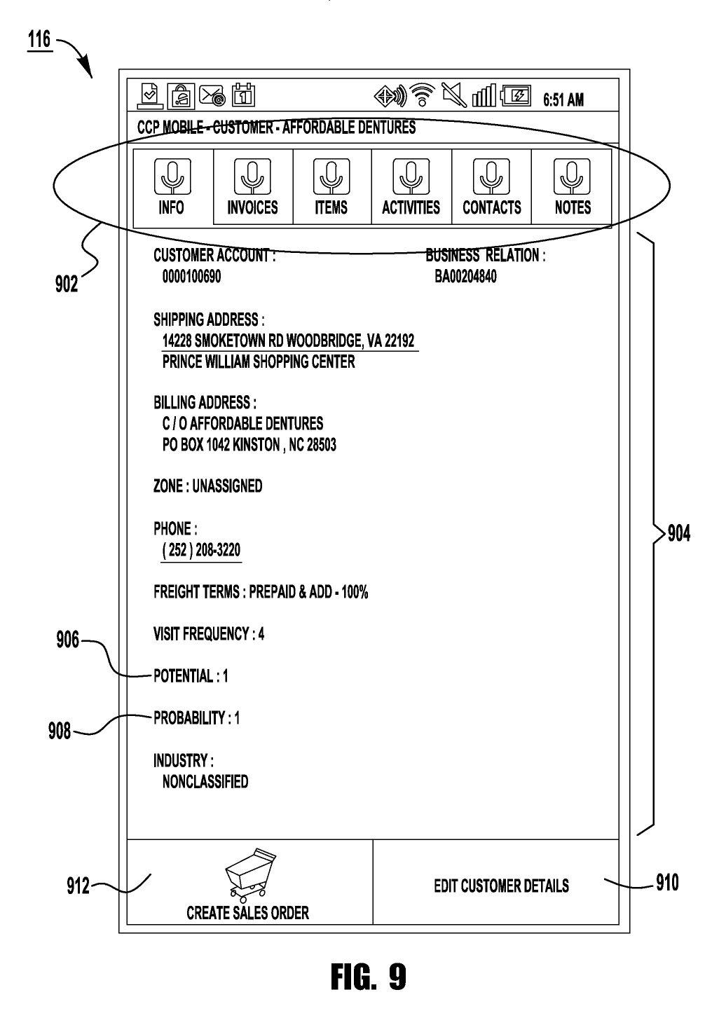

The user can also select a particular customer from the list of all customers or from some subset thereof (e.g., a filtered, sorted, and/or searched subset of customers) in step 814. Selecting a particular customer causes a detailed view of the customer to be displayed on the mobile device 116 in step 816. This is the default view for any given customer. This detailed view is displayed when the “customer detail” icon/feature is selected from anywhere in the SPS Application. For example, selecting the “info” icon from the customers sub-menu 902 (see FIG. 9) would bring up this default view. This detailed view includes a collection of customer information shown on a portion (e.g., the customer information portion 904) of the display of the mobile device 116. The customer information can include, for example, a customer name and/or identifier (e.g., account number), a phone number, a zone, freight terms, call frequency (e.g., in weeks), a potential measure, a probability measure, and a line of business.

The potential measure, such as potential measure 906 shown in FIG. 9, is a metric used to classify customers and leads in a manner that helps users allocate their time spent selling to the customers and leads. In one exemplary embodiment, the potential measure uses a scale from 1 to 4, with 1 being the highest and 4 being the lowest. The potential measure is based on the following query: if the user were to sell the customer company being measured all of the item types available for sale, how much gross profit after freight (GPAF) $ would be generated?

The following scale is based on a number of employees in the company and assumes that each employee of a customer or lead is valued at annual sales that would generate a total of $150 GPAF per employee. This value has been determined to be a valuable baseline even though customers differ and GPAF $ per employee will vary based on type of industry, geographical region and local market conditions. The scale is used to rank customers in terms of their business potential.

1. 100+ Employees and/or $15,000+ Annual GPAF Potential.

2. 50-99 Employees and/or $7,500-$14,850 Annual GPAF Potential.

3. 25-49 Employees and/or $3,750-$7,350 Annual GPAF Potential.

4. 10-24 Employees and/or $1,500-$3,600 Annual GPAF Potential.

The probability measure, such as probability measure 908 shown in FIG. 9, is a metric used to classify customers and leads in a manner that helps users allocate their time spent selling to the customers and leads. In one exemplary embodiment, the probability measure uses a scale from 1 to 4, with 1 being the highest and 4 being the lowest. The probability measure attempts to quantify the probability of success with a particular customer. The probability measure is based on what the user knows about the customer, the user's relationship with the customer, the relationship between the company and its current supplier, and how much of the customer's business the user believes he can receive. With these criteria in mind, the following scale is used to rank each customer in terms of probability of success.

1. High Probability=90%+ account penetration.

2. Good Probability=50%+ account penetration.

3. Some Probability=25%+ account penetration.

4. Low Probability=10%+ account penetration.

When the SPS Application is used to set up a new lead, the user will be prompted to enter a ranking for both the potential measure and the probability measure of the lead.

From the detailed view of the customer information presented in step 816, the user can choose to edit the customer information in step 818. In one exemplary embodiment, the user initiates the editing interface by selecting an “edit customer details” option 910 displayed on the mobile device 116 (see FIG. 9). Once the customer information is revised, the SPS Application places a “lead update” request in the request queue maintained by the user's mobile device 116, in step 820. Thereafter, processing returns to step 816 and the detailed view of the customer information.

From the detailed view of the customer information presented in step 816, the user can choose to view invoices for the customer in step 822. For example, the invoices interface is displayed when the “invoices” icon is selected from the customers sub-menu 902 (see FIG. 9). The invoices associated with the customer are displayed on the user's mobile device 116 and can include invoice information such as an invoice number, an invoice amount, an invoice date, etc. A “view customer” icon or the like is used to return to step 816 and the detailed view of the customer information.

From the detailed view of the customer information presented in step 816, the user can choose to view items the customer has previously purchased in step 824. For example, the purchased items interface is displayed when the “items” icon is selected from the customers sub-menu 902 (see FIG. 9). The purchased items associated with the customer are displayed on the user's mobile device 116 and can include related information such as an item name and/or identifier, the last time the item was sold to the customer, the quantity sold, the number of times sold, etc. A “view customer” icon or the like is used to return to step 816 and the detailed view of the customer information.

From the detailed view of the customer information presented in step 816, the user can choose to view past and upcoming activities with the customer in step 826. For example, the activities interface is displayed when the “activities” icon is selected from the customers sub-menu 902 (see FIG. 9). The activities associated with the customer are displayed on the user's mobile device 116 and can include related information such as a summary of the activities by type and status. From the activities sub-menu, the user can elect to create a new activity in step 828. Creation of a new activity allows the user to input or otherwise edit activity information such as date, time, contact, purpose, etc. By selecting this feature, the SPS Application places a “create activity” request in the request queue maintained by the user's mobile device 116, in step 830. From the activities sub-menu, the user can elect to close out an existing activity in step 832. By selecting this feature, the SPS Application places an “update activity” request in the request queue maintained by the user's mobile device 116, in step 834. A “view customer” icon or the like is used to return to step 816 and the detailed view of the customer information.

From the detailed view of the customer information presented in step 816, the user can choose to view contacts associated with the customer in step 836. For example, the contacts interface is displayed when the “contacts” icon is selected from the customers sub-menu 902 (see FIG. 9). The contacts associated with the customer are displayed on the user's mobile device 116 and can include related information such as the contact's name and contact information (e.g., phone number, mailing address, email address). From the contacts sub-menu, the user can elect to create a new contacts in step 838. By selecting this feature, the SPS Application places a “create contact” request in the request queue maintained by the user's mobile device 116, in step 840. From the contacts sub-menu, the user can elect to edit an existing customer contact in step 842. By selecting this feature, the SPS Application places an “update contact” request in the request queue maintained by the user's mobile device 116, in step 844. From the contacts sub-menu, the user can elect to delete an existing contact in step 846. By selecting this feature, the SPS Application places a “delete contact” request in the request queue maintained by the user's mobile device 116, in step 848. A “view customer” icon or the like is used to return to step 816 and the detailed view of the customer information.

From the detailed view of the customer information presented in step 816, the user can choose to place an order for the customer in step 850. In one exemplary embodiment, the user initiates the order placement interface by selecting a “create sales order” option 912 displayed on the mobile device 116 (see FIG. 9). The order placement interface allows the user to input sales orders via the SPS Application. A “view customer” icon or the like is used to return to step 816 and the detailed view of the customer information.

Other functions may be available from the detailed view of the customer information presented in step 816, such as a means for adding and/or removing notes associated with the customer. For example, a notes interface is displayed when the “notes” icon is selected from the customers sub-menu 902 (see FIG. 9).

In one exemplary embodiment, the SPS Application includes a software module or the like implementing the method 800, within the system 100.

A method 1000 implementing the order placement interface, according to one exemplary embodiment, is shown in FIG. 10. The method 1000 may be accessed, for example, from step 850 of the method 800 implementing the customers module 602.

As an initial matter, the user selects a particular customer for which the order is to be placed in step 1002. In one exemplary embodiment, if the user has arrived at the place order interface from the detailed view of a particular customer, that customer will automatically be selected as the customer for the order.

Then, the user enters order information for the order in step 1004. The order information can include, for example, a purchase order number, a shipping address, any attention to designation, terms of delivery, payment terms, etc. The order information can also include, for example, where to send confirmation of order placement, shipping notifications, invoices, etc.

In step 1006, it is determined if the payment terms include use of a credit card. If so, it is determined whether the customer is using a credit card that is on file (i.e., on file within the system 100) in step 1008. If the credit card is not already on file, the user must input information on the credit card in step 1010. The credit card information can include, for example, the cardholder's name, the credit card type, the credit card number, the expiration date, the security number, etc. If the credit card is already on file, the user need only select the appropriate credit card from a list of any credit cards on file for the customer, in step 1012.

Once the user inputs credit card information, a credit card on file for the customer is selected by the user, or it is determined that the payment terms do not include a credit card, processing continues to step 1014, wherein if the customer has placed orders before, the user can add items from the customer's previous history (which is stored by the system 100) to a shopping cart associated with the customer. Furthermore, in step 1016, the user can add additional items from the full catalog of items to the customer's order.

Thereafter, if the user indicates that the order is complete, order completion is acknowledged in step 1018. Here, the user can still update the order, for example, by changing the selling price, shipping warehouse, etc. The user can also review the profitability of the order at this time. The user can also calculate freight weights at this time. The user can cause processing to return to step 1014 (and, thus, step 1016 as well) to add any additional items if desired.

Once the user is satisfied with the order, the user can place the order into the system 100, suspend/hold the shopping cart for later use, or delete the contents of the shopping cart entirely, in step 1020. At this time, the user can also generate a quote letter based on the contents of the shopping cart.

In one exemplary embodiment, the SPS Application includes a software module or the like implementing the method 1000, within the system 100.

To assist in explaining the zone setup module 604 and the zone schedule module 606, an exemplary territory initialization process will be described.

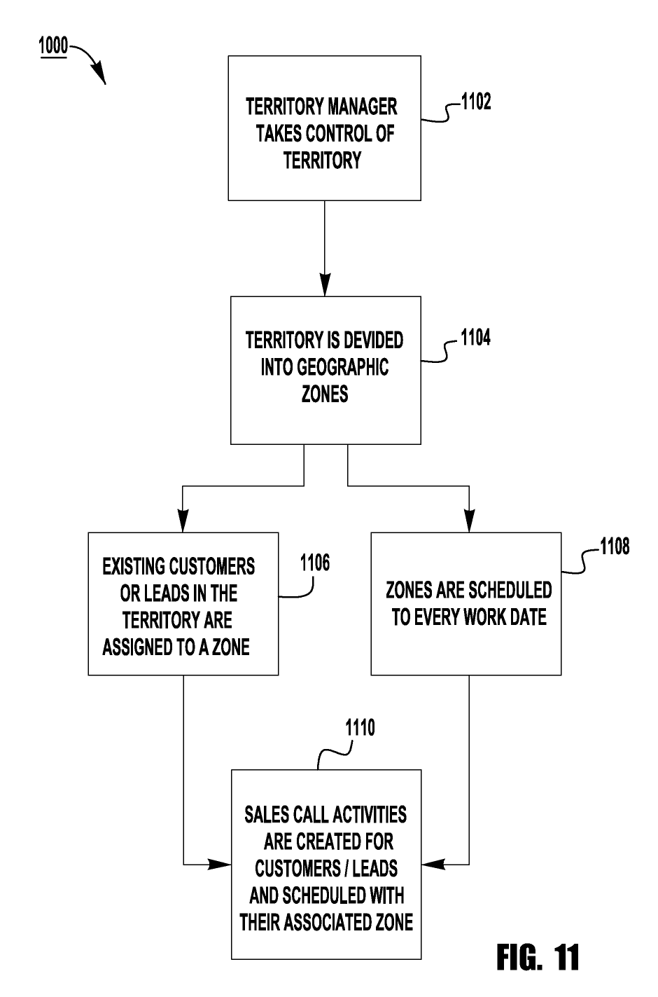

A method 1100 of managing a territory for sales purposes, according to one exemplary embodiment, is shown in FIG. 11. In the method 1100, a territory manager, such as a user or other manager, identifies or is assigned a particular territory 1202 in step 1102. Thereafter, the user divides the territory 1202 into a number of discrete geographic zones 1204 in step 1104. The boundaries of the zones 1204 are generally chosen based on knowledge or information in the user's possession. For example, the zones 1204 are designed by the user to include potential new customers (i.e., “leads”) who might be developed into buying customers. The zones 1204 can be adjusted from time to time based on the potential for new business, any special customer needs, etc.

Each zone 1204 is assigned a number and given a description (e.g., using zip codes, town names, city names). One or more non-numbered zones can also be created, such as for administrative purposes. Such administrative zones could include a “dead” zone where users can put customers and leads that are no longer active or otherwise being worked; a holiday/vacation zone to account for days that are not being worked due to a holiday or vacation; a training zone to account for days that not being worked due to user training; and an administrative zone to account for any other days not being worked and/or to log any administrative matters.

Thereafter, the user can assign existing customers and leads in the territory 1202 to the corresponding zones 1204 in step 1106. Typically, each zone will contain those customers and leads whose facility is physically located within the zone's geographical boundaries. In one exemplary embodiment, customers and leads can only be assigned to a single zone. The zones 1204 are also scheduled to corresponding work days of the user in step 1108. The user can then create sales call activities for the customers and leads, which are scheduled with their associated zones 1204, in step 1110.

In one exemplary embodiment, the SPS Application includes a software module or the like implementing the method 1100, within the system 100.

The zones 1204 (e.g., defined according to the method 1100) help develop consistency in communications with customers, which encourages the development of customer confidence and trust. By promoting consistent communications with customers in combination with pre-planned selling ideas for each sales activity, the SPS Application helps users increase their value to their customers and improve their account penetration which makes them more important to their customers' business. The zones 1204 also aid the users in assisting their customers in managing inventory.

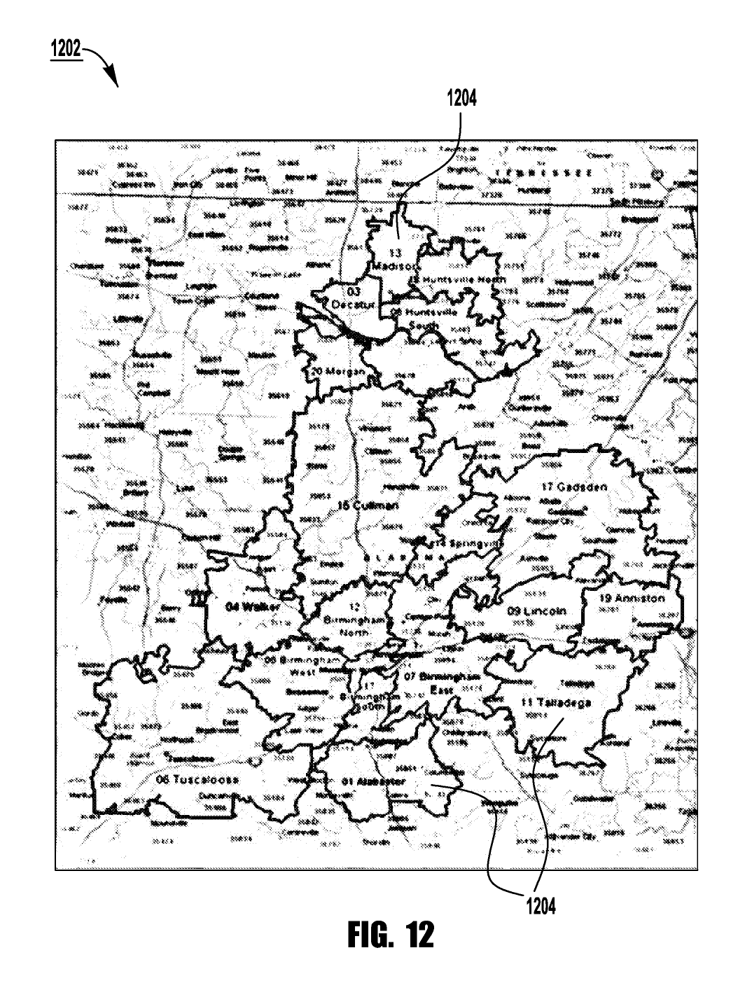

In one exemplary embodiment, a sales cycle is 20 days (four weeks) which results in 13 sales cycles in a calendar year. In one exemplary embodiment, a sales cycle is one month such that there are 12 sales cycles in a year. As noted above, the method 1100 allows a territory 1202 to be decomposed into a number of sales zones 1204 that represent geographical boundaries with meaningful descriptions. The zones are numbered and allocated in such a way that makes it possible for the user to develop a consistent sales cycle with current customers and prospective customers (i.e., leads) in relation to any “activities” (e.g., sales calls, telephone calls, email communications, face-to-face interactions). In one exemplary embodiment, the territory 1202 is divided into 20 zones 1204 (see FIG. 12), with each zone 1204 representing a work day in the sales cycle. In one exemplary embodiment, zones 1, 6, 11 and 16 are always visited or otherwise engaged (activities conducted) on a Monday; zones 2, 7, 12 and 17 are always engaged on a Tuesday; zones 3, 8, 13 and 18 are always engaged on a Wednesday; zones 4, 9, 14 and 19 are always engaged on a Thursday; and zones 5, 10, 15 and 20 are always engaged on a Friday. Thus, the zones 1204 are designed, for example, to keep the user focused, promote consistency, minimize travel (e.g., driving) time, and maximize selling time.

One of ordinary skill in the art will appreciate that a territory could be divided into any number of zones 1204. The general inventive concepts, as embodied in the SPS Application, are flexible and scalable. For example, the number of zones and frequency of visits thereto can be tailored to each type of product or business for which the SPS Application is being adapted or used.

As described herein, zones (e.g., the zones 1204) are geographical areas for each selling day. The zone setup module 604 provides an interface between the user's mobile device 116 (i.e., the SPS Application) and data relating to the zones stored in the data stores 108 (e.g., the staging database 112). For example, the zone setup module 604 allows users to create and define the zones, add members (e.g., customers, leads) to zones, view past and future visits into zones, etc.

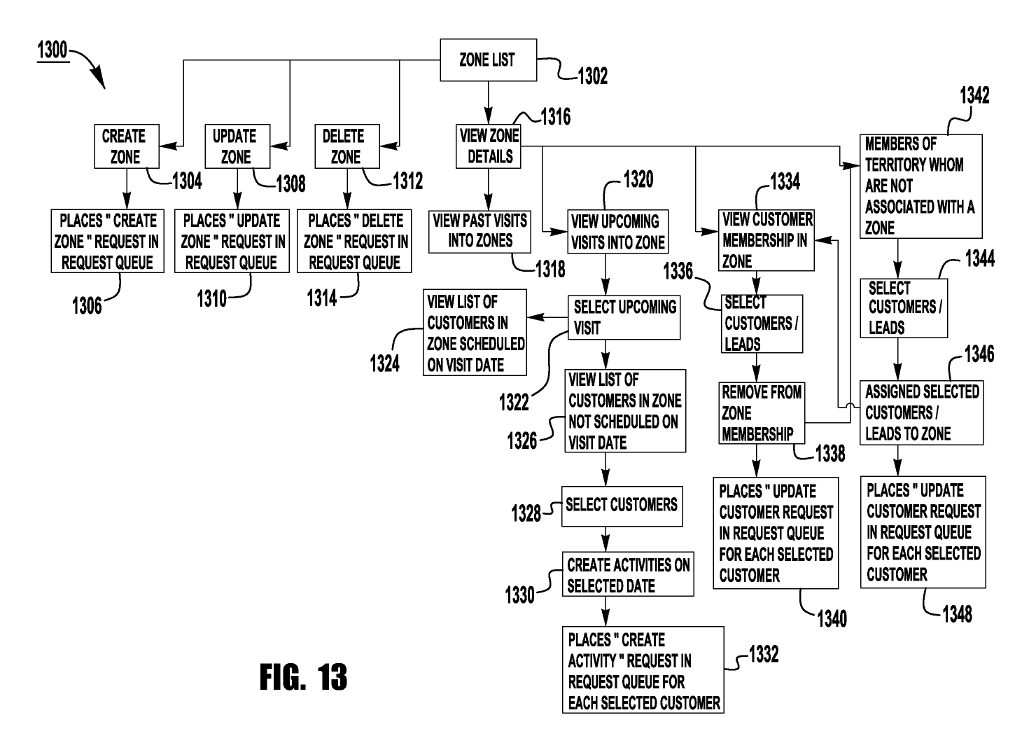

A method 1300 implementing the zone setup module 604, according to one exemplary embodiment, is shown in FIG. 13. In the method 1300, a default view listing all zones for a selected territory (e.g., the territory 1202) is displayed in step 1302. Initially, there may be zero zones defined for the territory, if the territory is being set up for the first time, such as shown in FIG. 11. Portions of the list which are not currently visible on the display of the mobile device 116 can be scrolled to or otherwise brought into view by interacting with the zone setup module 604.

From this default view listing all zones for the territory, the user can perform various zone-related functions. For example, the user can create a new zone in step 1304, which results in the SPS Application placing a “create zone” request in the request queue maintained by the user's mobile device 116 in step 1306. In step 1308, the user can update a selected zone to edit its details (e.g., zone number, name/description, etc.), which results in the SPS Application placing an “update zone” request in the request queue maintained by the user's mobile device 116 in step 1310. The user can also delete a selected zone in step 1312, which results in the SPS Application placing a “delete zone” request in the request queue maintained by the user's mobile device 116 in step 1306.

The user can also select a particular zone from the list of all zones or from some subset thereof (e.g., a filtered, sorted, and/or searched subset of zones) in step 1316. In one exemplary embodiment, the zones each have a different color to more readily distinguish them from one another. By selecting a particular zone, a detailed view of the zone is displayed on the mobile device 116 in step 1316. This detailed view includes a collection of zone information shown on the display of the mobile device 116. The zone information can include, for example, a zone number and a zone name or description.

From this detailed view of a particular zone, the user can elect to view past visits into the zone in step 1318. For example, the user can review specific details (e.g., all scheduled activities) for the zone by visit date.

From this detailed view of a particular zone, the user can also elect to view upcoming visits into the zone in step 1320. From the list of upcoming visits into the zone, the user can select a particular upcoming visit in step 1322. Thereafter, the user can view a list of customers in the zone for which a visit is scheduled on the visit date, in step 1324. Likewise, the user can view a list of customers in the zone for which a visit is not scheduled on the visit date, in step 1326. In this case, one of the non-scheduled customers can be selected by the user in step 1328. The user can then create activities on the visit date for the selected non-scheduled customer, in step 1330. As a result, the SPS Application places a “create activity” request in the request queue maintained by the user's mobile device 116 in step 1332.

From the detailed view of a particular zone, the user can elect to view customer membership in the zone, i.e., all customers who are associated with the zone, in step 1334. From this list of member customers, the user can select a particular customer or lead in step 1336. Thereafter, the user can choose to remove the particular customer or lead in step 1338. As a result, the SPS Application places an “update customer” request in the request queue maintained by the user's mobile device 116 in step 1332. In this manner, customers and leads can be removed from a zone.

From the detailed view of a particular zone, the user can elect to view non-member customers, i.e., all customers in the territory who are not associated with a zone of the territory, in step 1342. From this list of non-member customers, the user can select a particular customer or lead in step 1344. Thereafter, the user can assign the particular customer or lead to a zone of the territory in step 1346. As a result, the SPS Application places an “update customer” request in the request queue maintained by the user's mobile device 116 in step 1348. In this manner, customers and leads can be added to a zone.

In one exemplary embodiment, the user can elect to return to the default view listing all zones (i.e., the processing of step 1302) at any time. In one exemplary embodiment, the SPS Application automatically returns the user to the default view listing all zones (i.e., the processing of step 1302) after a request is placed in the request queue of the user's mobile device 116. In one exemplary embodiment, the user can elect to return to the detailed view of the zone (i.e., the processing of step 1316) at any time. In one exemplary embodiment, the SPS Application automatically returns the user to the detailed view of the zone (i.e., the processing of step 1316) after a request is placed in the request queue of the user's mobile device 116.

In one exemplary embodiment, the SPS Application includes a software module or the like implementing the method 1300, within the system 100.

The zone schedule module 606 provides an interface between the user's mobile device 116 (i.e., the SPS Application) and schedule information relating to the zones (e.g., the zones 1204) stored in the data stores 108 (e.g., the staging database 112). For example, the zone schedule module 606 can be used as a contact manager by the user.

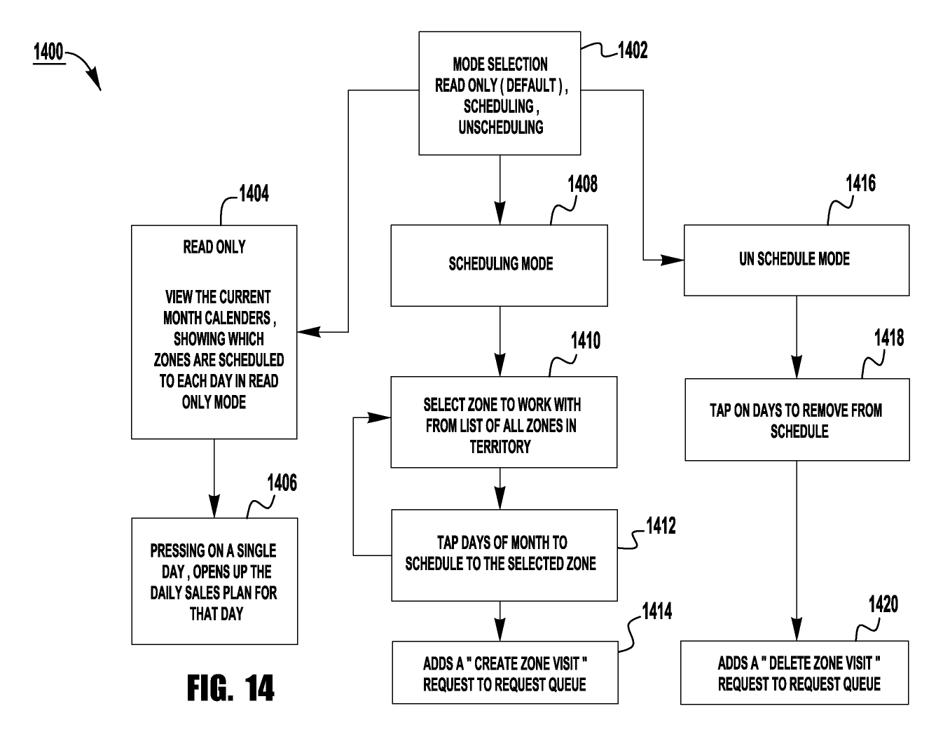

A method 1400 implementing the zone schedule module 606, according to one exemplary embodiment, is shown in FIG. 14. The method 1400 allows the user to select from among different modes in step 1402. In one exemplary embodiment, the method 1400 includes a view (i.e., read-only) mode, a schedule mode, and an un-schedule mode.

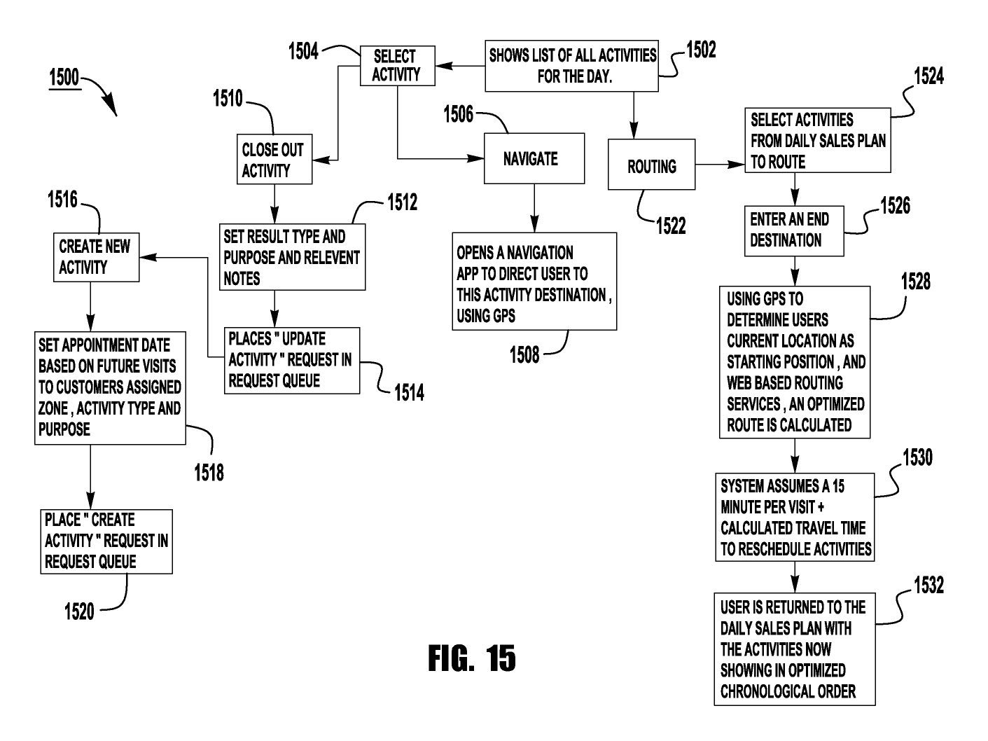

Selection of the view mode in step 1402 takes the user to the view mode within the zone schedule module 606. The view mode allows the user to view a calendar (e.g., a monthly calendar corresponding to a particular sales cycle) in step 1404. The calendar shows which zones are scheduled on each day. By selecting a particular day from the calendar in step 1406, the user opens up a daily sales plan (see FIG. 15) for that day.

Selection of the schedule mode in step 1402 takes the user to the schedule mode within the zone schedule module 606. In step 1408, the schedule mode allows the user to schedule zone visit dates using the list of zones and the calendar. The user first selects a particular zone from a list of all zones in the territory, in step 1410. The user then selects which day or days of the month (from the calendar) to associate with the selected zone, in step 1412. As a result, the SPS Application places a “create zone visit” request in the request queue maintained by the user's mobile device 116 in step 1414. In this manner, the user can readily schedule zone visits.

Selection of the un-schedule mode in step 1402 takes the user to the un-schedule mode within the zone schedule module 606. In step 1416, the un-schedule mode allows the user to disassociate a zone from a scheduled visit date. The user need only select a particular day or days (from the calendar), in step 1418, to remove those days from the schedule. As a result, the SPS Application places a “delete zone visit” request in the request queue maintained by the user's mobile device 116 in step 1414. In this manner, the user can readily un-schedule zone visits.

In one exemplary embodiment, the SPS Application includes a software module or the like implementing the method 1400, within the system 100.

The zone schedule module 606 is a useful tool in promoting consistency by the user. For example, a zone 01 is always scheduled on the first week day of each month. Then, zones 02 through 20 follow in numeric order. By working daily from zone 01 to zone 20, the user will always call on his customers and leads at the same time of the month and at the same time each day. This type of call pattern allows the user to see or contact (e.g., in person, by phone, by email) each customer and lead accordingly to a repetitive, predictable schedule. This level of organization, and the associated degree of consistency, helps the user build a trusting, long-term business relationship with his customers and leads.

The daily sales plan module 608 provides an interface between the user's mobile device 116 (i.e., the SPS Application) and daily sales plan information stored in the data stores 108 (e.g., the staging database 112). For example, the daily sales plan module 608 allows the user to arrange his activities geographically in the sequence in which he will call on customers and leads within that zone.

The daily sales plan module 608 also aids the user in keeping unnecessary driving time to a minimum, thereby allowing the user more time to make contacts. For example, the daily sales plan module 608 includes a routing tool which helps the user plan the best driving route to cover the day's activities.

The daily sales plan module 608 allows the user to develop daily sales plans (e.g., in conjunction with the zone schedule module 606) for keeping track of who, where, when, and what with respect to each selling day. At the start of each business day, the user should use his mobile device 116 to review his daily schedule and sales plan to identify any customers or leads that need to be seen more than once a sales cycle and will require the user to leave today's zone. For example, if the user is working in zone 05 today and a customer or lead in zone 10 needs to be visited, the user should try to make that call either his first or last call for the day.

A method 1500 implementing the daily sales plan module 608, according to one exemplary embodiment, is shown in FIG. 15. The method 1500 allows the user to view his list of activities for the current day, route his calls, and close out after each activity is completed.

In the method 1500, a default view lists all activities for the current workday (only a portion of which may be visible on the screen at any given time) in step 1502. Any activities which are not currently visible on the display of the mobile device 116 can be scrolled to or otherwise brought into view by interacting with the daily sales plan module 608.

From the default view listing all activities, the user can select a particular activity in step 1504. In one exemplary embodiment, selection of the particular activity brings up more detailed information relating to the activity. This detailed information can include, for example, the customer or lead associated with the activity, the type of activity, the activity name, the date and time of the activity, the purpose of the activity, a contact person at the customer or lead, etc.

After selecting the particular activity, the user can activate a navigate function (in step 1506) of the daily sales plan module 608. Activation of the navigate function opens a navigation application (in step 1508) to direct the user to the location associated with the selected activity (e.g., using GPS).

After selecting the particular activity, the user can elect to close out the activity in step 1510. To close out the activity, the user inputs (e.g., selects from a list of choices) the result type that best describes the outcome of the activity in step 1512. The result type could be, for example, contact unavailable-call back, sale of new item, reorder, no sale, problem at account, lost account, customer has enough inventory, no call made/reschedule, appointment made, etc. The user can also input any notes from the activity that the user wants to save for possible use in the future, in step 1512. After inputting this information, the user confirms that activity is to be closed in step 1512. As a result, the SPS Application places an “update activity” request in the request queue maintained by the user's mobile device 116 in step 1514.

In the method 1500, the user can also elect to create a new activity in step 1516, such as from the default listing of all current activities in step 1504. To create a new activity, the user sets an appointment date based on future visits scheduled to the customer's zone, and identifies the type and purpose of the activity, in step 1518. As a result, the SPS Application places a “create activity” request in the request queue maintained by the user's mobile device 116 in step 1520.

In one exemplary embodiment, the method 1500 supports other activity functions such as editing an activity, deleting an activity, scheduling a next activity, etc.

From the default view listing all activities, the user can select a routing function in step 1522. The routing function selects activities, starting with the user's current location and finishing at an end location, to place the activities in the most efficient order for the user, thereby minimizing or otherwise reducing driving time for the day's activities. The routing function calculates driving times from the user's starting location to each activity location in driving minutes and allocates 15 minutes per activity for up to a total of 25 activities.

In step 1524, the user selects one or more activities from the daily sales plan to route. In one exemplary embodiment, the SPS Application defaults to selecting all of the day's activities for routing. Then, the user specifies an end destination in step 1526. GPS is used to determine the user's current location in step 1528. Based on the user's current location and the end destination input by the user, a routing application (e.g., a web-based routing service) is used to calculate an optimized route for the user relative to his daily activities, in step 1528. Based on an assumed 15 minutes per activity plus calculated travel time, any activities that cannot be efficiently reach this day are rescheduled in step 1530. Thereafter, the user is returned to his daily sales plan (e.g., the processing of step 1502) with the day's activities displayed in an optimizied chronological order, in step 1532.

In one exemplary embodiment, the SPS Application includes a software module or the like implementing the method 1500, within the system 100.

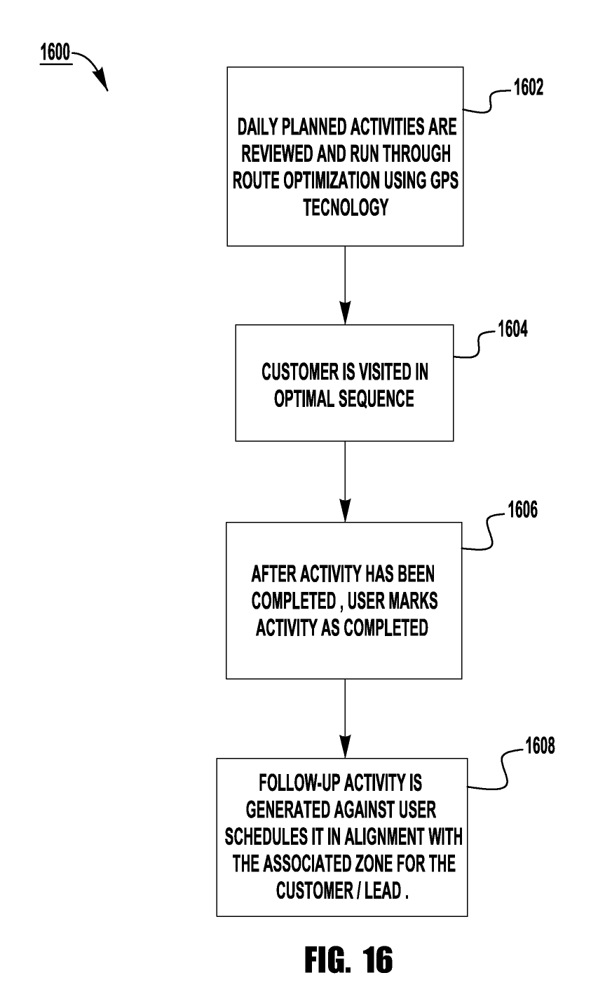

A method 1600 for managing daily activities, according to one exemplary embodiment, is shown in FIG. 16. The method 1600 utilizes the daily sales plan module 608 described herein.

In step 1602, all daily planned activities are processed by a route optimization program (e.g., using GPS technology) to create an optimized driving route for visiting the customer or lead associated with each of the activities. The user then visits the customers and leads in the optimal sequence in step 1604. After each activity has been completed, the user marks the activity as completed (e.g., within the SPS Application) in step 1606. Follow-up activity is generated, as needed, and scheduled in alignment with the zone for the customer or lead in step 1608.

In one exemplary embodiment, the SPS Application includes a software module or the like implementing the method 1600, within the system 100.

The open orders module 610 provides an interface between the user's mobile device 116 (i.e., the SPS Application) and order information stored in the data stores 108 (e.g., the staging database 112). For example, the open orders module 610 shows all open orders that are in the system 100 for a specified territory of the user, along with the current status of each order. In one exemplary embodiment, the order information is updated periodically (e.g., every 30 minutes) during the synchronization process.

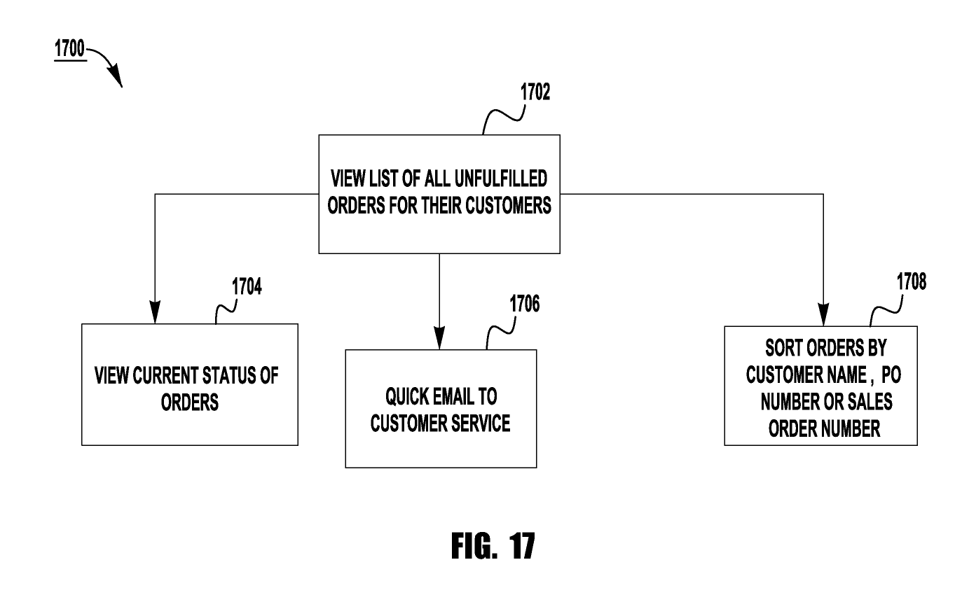

A method 1700 implementing the open orders module 610, according to one exemplary embodiment, is shown in FIG. 17. The method 1700 allows the user to view a list of all unfulfilled orders for his customers in step 1702. From this list, the user can view the details of an order (e.g., order number, date of entry, date of conformity, pick date, pack date, invoice date), including a current status of the order, in step 1704. In step 1706, the user can generate an email or similar communication to a customer service representative or office, if needed, wherein the communication automatically references the order number. From the list of all unfulfilled orders for his customers (i.e., the processing of step 1702), the user can sort the orders in step 1708. In one exemplary embodiment, the orders can be sorted by customer name, purchase order number, or order number.

In one exemplary embodiment, the SPS Application includes a software module or the like implementing the method 1700, within the system 100.

The sales history module 612 provides an interface between the user's mobile device 116 (i.e., the SPS Application) and sales history information stored in the data stores 108 (e.g., the staging database 112). For example, the sales history module 612 provides the user with a snapshot of sales performance across any number of periods of time. The sales history module 612 allows the user to view invoiced orders for all customers. In one exemplary embodiment, the user specifies a predefined date range (e.g., today, yesterday, current pay period, last pay period, current month to date, previous month, year to date, fiscal year to date) for which invoiced orders are to be shown.

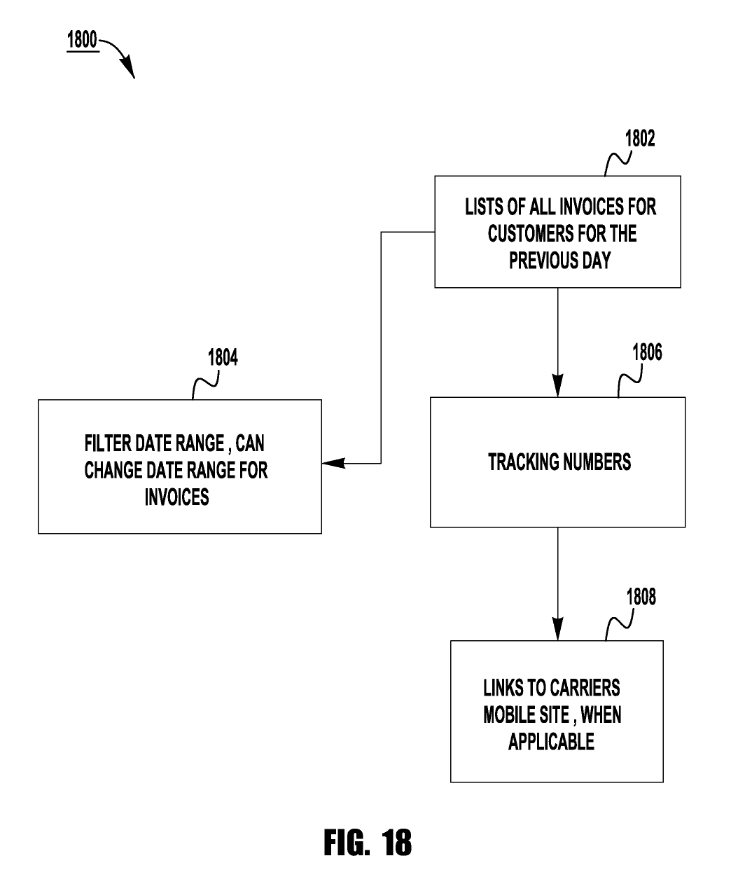

A method 1800 implementing the sales history module 612, according to one exemplary embodiment, is shown in FIG. 18. The method 1800 allows the user to view a list of all customer invoices. As the default view, all customer invoices for the previous day are displayed in step 1802. In step 1804, the user can change the date range to filter which customer invoices are displayed. From the list of invoices, the user can look up tracking numbers for the underlying orders in step 1806. In one exemplary embodiment, a carrier's website is loaded in step 1808 so that the tracking numbers can be used to confirm carrier information on the underlying orders.

In one exemplary embodiment, the SPS Application includes a software module or the like implementing the method 1800, within the system 100.

The item history module 614 provides an interface between the user's mobile device 116 (i.e., the SPS Application) and item history information stored in the data stores 108 (e.g., the staging database 112). For example, the item history module 614 provides details on every item sold in the territory, including associated customer information, invoice information, and sales information (e.g., the date of sale, the price).

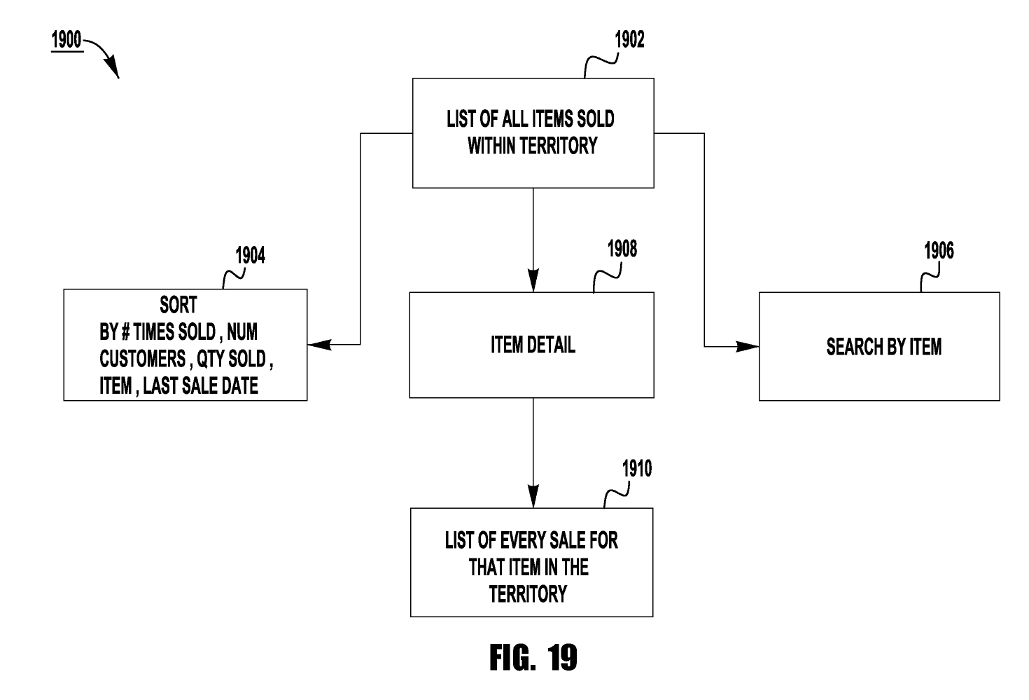

A method 1900 implementing the item history module 614, according to one exemplary embodiment, is shown in FIG. 19. The method 1900 allows the user to view a list of all items sold within the territory in step 1902. Based on the full view of the items sold, the user can specify criteria for sorting the displayed items in step 1904. For example, the criteria could include the item number, the number of times the item was sold, the number of different customers the item was sold to, the quantity of the item sold, the last date of sale for the item, etc. Furthermore, based on the full view of the items sold, the user can elect to search for a specific item in step 1906. In particular, the user can enter any alphanumeric search string in an attempt to locate a specific item within the list. In step 1908, the user can select a specific item from a list of items to view more detailed information on the item's sales history. Once the specific item is selected, a list of every sale for the item in the territory is displayed in step 1910. In one exemplary embodiment, the list of sales for the item is ordered by customer and from the most recent sale to the oldest sale.

In one exemplary embodiment, the SPS Application includes a software module or the like implementing the method 1900, within the system 100.

The open activities module 616 (also called the “close activity” module) provides an interface between the user's mobile device 116 (i.e., the SPS Application) and information on open activities stored in the data stores 108 (e.g., the staging database 112). For example, the open activities module 616 allows the user to manage past due activities.

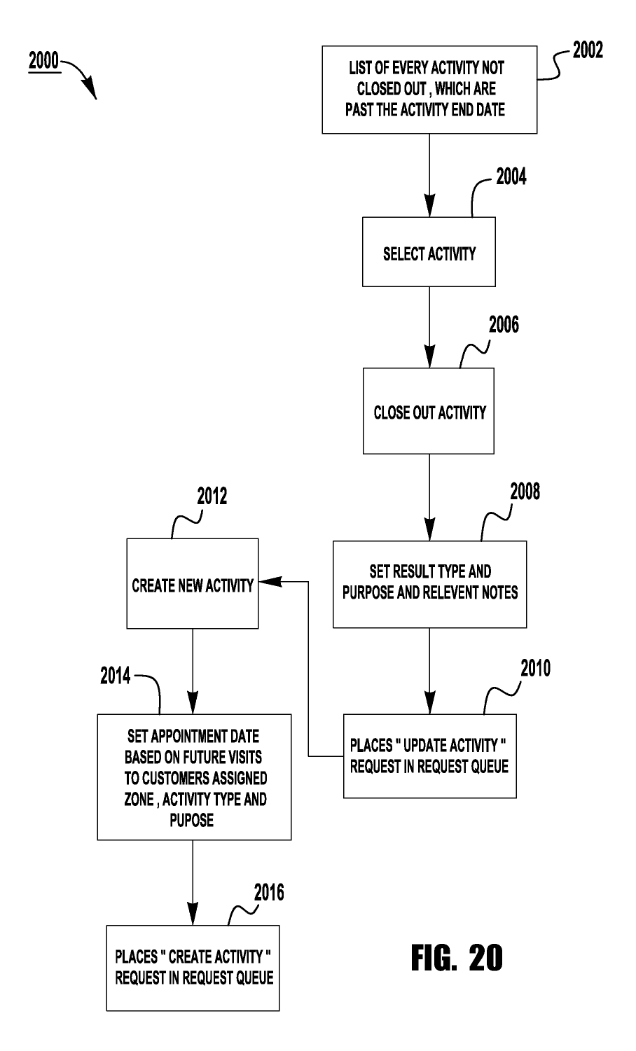

A method 2000 implementing the open activities module 616, according to one exemplary embodiment, is shown in FIG. 20. The method 2000 allows the user to view a list of his past due activities that have not yet been closed out.

In the method 2000, a list of all activities for the user which are past their respective activity end dates and are not yet closed is displayed in step 2002. From this list, the user selects a particular activity in step 2004. Then, the user indicates that the selected activity is to be closed in step 2006. To close out the activity, the user inputs (e.g., selects from a list of choices) the result type that best describes the outcome of the activity in step 2008. The result type could be, for example, contact unavailable-call back, sale of new item, reorder, no sale, problem at account, lost account, customer has enough inventory, no call made/reschedule, appointment made, etc. The user can also input any notes from the activity that the user wants to save for possible use in the future, in step 2008. After inputting this information, the user confirms that activity is to be closed in step 2008. As a result, the SPS Application places an “update activity” request in the request queue maintained by the user's mobile device 116 in step 2010.

Closing out the past due activity takes the user to a create new activity function in step 2012. This allows the user to plan a future activity in place of the activity that was just closed out. To create a new activity, the user sets an appointment date based on future visits scheduled to the customer's zone, and identifies the type and purpose of the activity, in step 2014. As a result, the SPS Application places a “create activity” request in the request queue maintained by the user's mobile device 116 in step 2016.

In one exemplary embodiment, the SPS Application includes a software module or the like implementing the method 2000, within the system 100.

The sync module 618 provides an interface between the user's mobile device 116 (i.e., the SPS Application) and the web server 106 to allow the user to manually initiate a synchronization process. When the user inputs a “sync” command using the SPS Application on his mobile device 116, the sync command is sent to the web server 106 to initiate the synchronization process. In one exemplary embodiment, the synchronization process is the method 400 (see FIG. 4).

The past due invoices module 620 provides an interface between the user's mobile device 116 (i.e., the SPS Application) and information on outstanding invoices stored in the data stores 108 (e.g., the staging database 112). For example, the past due invoices module 620 allows the user to manage those customer invoices which have not been paid in the allotted time.

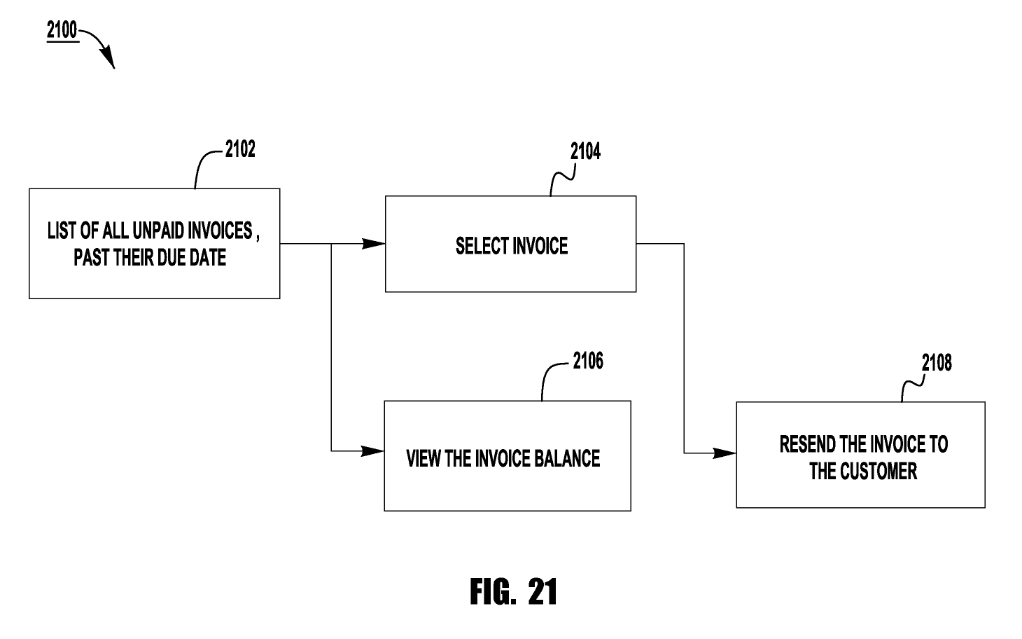

A method 2100 implementing the past due invoices module 620, according to one exemplary embodiment, is shown in FIG. 21. In one exemplary embodiment, the method 2100 is only accessible by the user when one or more customers owes monies. In the method 2100, a list of all unpaid invoices which are past their due dates is displayed in step 2102. From this list, the user can select a particular past due invoice in step 2104. Furthermore, by selecting the particular invoice, additional details on the invoice can be displayed including, for example, customer information, invoice number, invoice date, days past due, amounts past due, etc. In step 2106, the outstanding balance for a selected invoice is displayed. Based on review of the invoice details, the user can cause the past due invoice to be re-sent to the customer in step 2108.

In one exemplary embodiment, the SPS Application includes a software module or the like implementing the method 2100, within the system 100.

The cloning module 622 allows a manager to view territory information associated with all of the users that directly report to the manager. Thus, the cloning module 622 effectively allows the manager to duplicate the mobile devices 116 of these users. This is also referred to as “impersonating” a user.

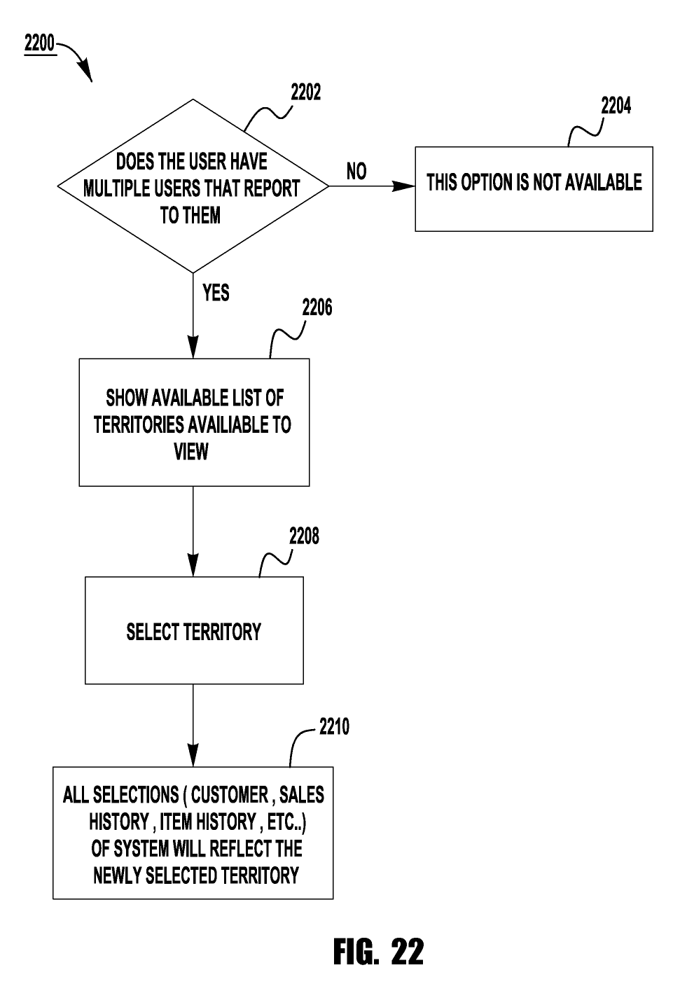

A method 2200 implementing the cloning module 622, according to one exemplary embodiment, is shown in FIG. 22. As an initial matter, it is determined in step 2202 whether the manager has multiple users that report to him. If not, the manger is denied further access to the cloning module 622 in step 2204. If multiple users do report to the manager, a list of territories corresponding to those users is displayed in step 2206. The manager can then select one of the listed territories to view in step 2208. Thereafter, in step 2210, other active modules (e.g., the customers module 602, the sales history module 612) of the system 100 will reflect the newly selected territory.

In one exemplary embodiment, the SPS Application includes a software module or the like implementing the method 2200, within the system 100.

The library module 624 provides an interface between the user's mobile device 116 (i.e., the SPS Application) and sales support data stored in the data stores 108 (e.g., the staging database 112) and/or in the mobile device 116 itself. In one exemplary embodiment, the sales support data is maintained in the data stores 108, stored locally in the mobile device 116, and updated periodically during the synchronization process. The sales support data can include any information that supports the sales function of the users including, for example, sales and marketing information, special order products, vendor catalogs, pricing, costs, technical data, national accounts, promotions and training information for reference by the users and to forward to customers, etc. The SPS Application provides an interface for the users to navigate this sales support data including, for example, viewing the data, searching the data, sorting the data, emailing the data, etc.

The reports module 626 provides an interface between the user's mobile device 116 (i.e., the SPS Application) and report information stored in the data stores 108 (e.g., the staging database 112). For example, the reports module 626 allows the user to select from a list of available reports. The report is then generated and provided (e.g., emailed) to the user. In one exemplary embodiment, the user can define or otherwise create a report template.

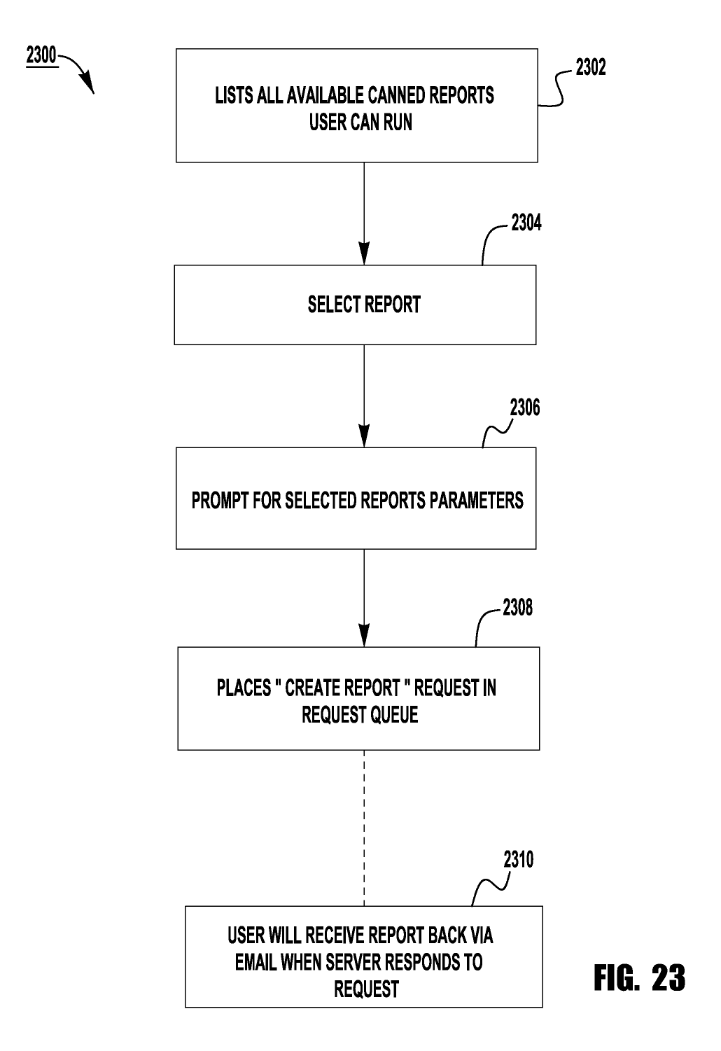

A method 2300 implementing the reports module 626, according to one exemplary embodiment, is shown in FIG. 23. The method 2300 allows the user to generate reports based on data stored in the data stores 108. In the method 2300, a list of available reports is displayed in step 2302. From this list, the user can select a desired report in step 2304. Thereafter, the user is prompted for parameters relating to generation of the report in step 2306. Once the user has input the report parameters, the SPS Application places a “create report” request in the request queue maintained by the user's mobile device 116 in step 2308. The “create report” request eventually arrives at the web server 106 (acting as a Report Server interfaced with the data stores 108). The Report Server generates a report corresponding to the user's report selection and input parameters. The Report Server then sends (e.g., emails) the generated report back to the user, in step 2310.

One exemplary report is the user scorecard report that allows the user to evaluate the results of a sales cycle by reviewing the number of sales calls, the number of closed activities, the number of booked orders, the close rate, the number of lines, the number of lines per order, the sales amount, the sales amount per order, the gross profit before freight (GPBF), and the GPBF per order. The user scorecard report could aid the user, for example, in determining whether personal goals were met, in identifying areas for improvement, etc.

Another exemplary report is a territory development report that allows the user to measure development progress of a territory based on monthly results of the zones defined within the territory. The territory report could aid the user, for example, in identifying zones that need additional leads. The territory report could also aid the user in determining whether the zone geography needs to be redefined for the territory.

In one exemplary embodiment, the SPS Application includes a software module or the like implementing the method 2300, within the system 100.

The trade agreements module 628 provides an interface between the user's mobile device 116 (i.e., the SPS Application) and pricing agreements, arrangements, plans, and the like, with customers stored in the data stores 108 (e.g., the staging database 112). For example, the trade agreements module 628 allows the user to update his sell price for customers and prepare for upcoming price increases.

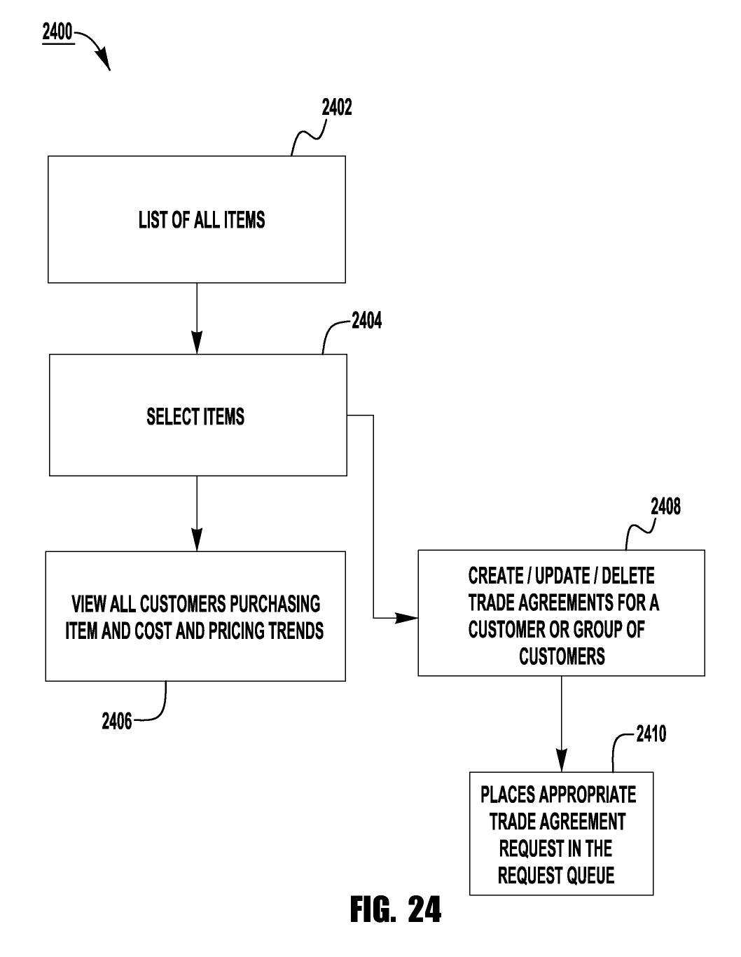

A method 2400 implementing the trade agreements module 628, according to one exemplary embodiment, is shown in FIG. 24. The method 2400 allows the user to manage trade agreements in place with a customer or group of customers, as well as adjust to changes in pricing structure. In the method 2300, a list of items, products, or the like offered for sale is displayed in step 2402. As described herein, the user can sort, filter, and/or search this list of items. The user selects a particular item in step 2404. In step 2406, the user can then view information related to the selected item, such as which customers are purchasing the item, cost and pricing trends associated with the item, etc.

After selecting the particular item, the user can also manage any trade agreements relating thereto in step 2408. For example, the user can create a new trade agreement relating to the item for a customer or group of customers, update an existing trade agreement, or delete a trade agreement, after which time the SPS Application places a corresponding trade agreement request in the request queue maintained by the user's mobile device 116 in step 2410.

In one exemplary embodiment, the SPS Application includes a software module or the like implementing the method 2400, within the system 100.

The SPS Application can, of course, include other software modules or the like. For example, in one exemplary embodiment, the SPS Application includes a price book module that allows a user to access an electronic price book maintained by the system 100. The price book module provides an interface between the user's mobile device 116 (i.e., the SPS Application) and price book information stored in the data stores 108 (e.g., the staging database 112). The price book module allows the user to search for products by item name or item number, or generally browse the products by product category.

The SPS Application can also provide assessment tools, modules, or the like. In one exemplary embodiment, the SPS Application includes a daily manager review module. The daily manager review module provides an interface by which a manager (e.g., a district manager) can use his mobile device 116 (i.e., the SPS Application) to assess the performance of one or more users (i.e., area managers) that report to him.

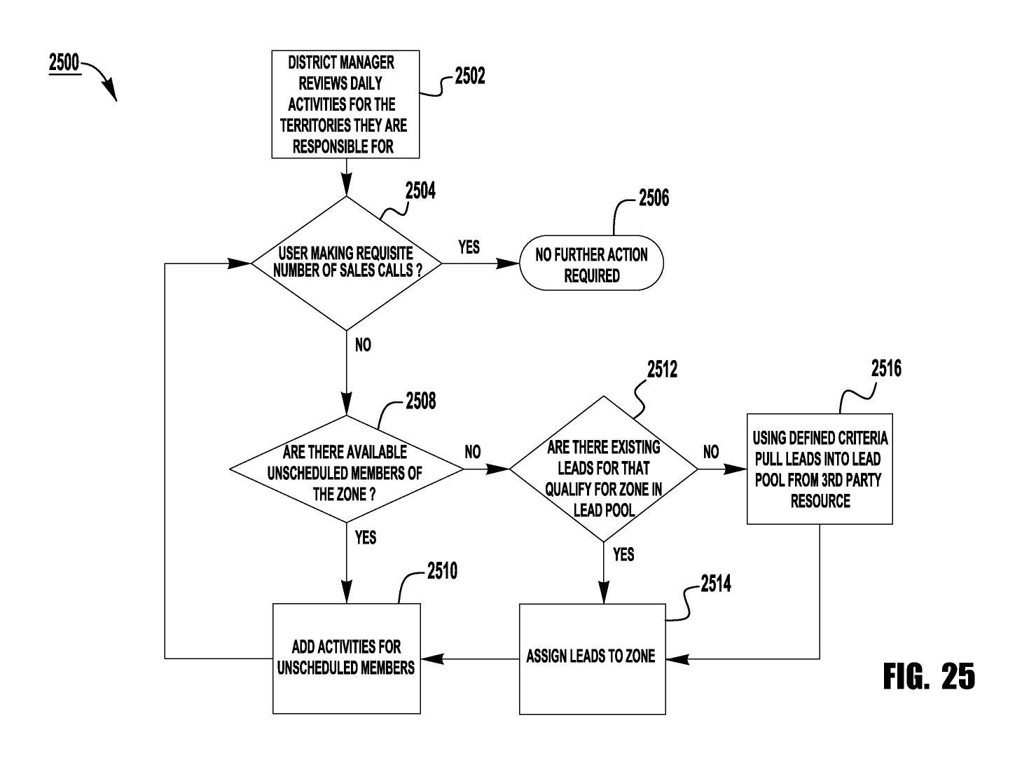

A method 2500 implementing the daily manager review module, according to one exemplary embodiment, is shown in FIG. 25. The method 2500 allows the manager to review the daily activities for the territories he manages in step 2502. Based on this information, it is determined (in step 2504) whether each user is making the requisite number of sales calls (e.g., 20 or more) in each of the user's zones. If is determined that the user is making the requisite number of sales calls in each zone, it is decided in step 2506 that no further action is necessary for that user. If, however, it is determined that the user is not making the requisite number of sales calls in each zone, it is determined whether there are any available, unscheduled members (i.e., customers) in those zones for which the deficiency exists, in step 2508. If so, the manager can add activities for one or more of the unscheduled members to the user's sales plan in step 2510. In one exemplary embodiment, the manager can direct the user to add such activities instead. If, however, it is determined that there are no available, unscheduled members in the user's deficient zones, it is then determined whether there are any leads in the existing lead pool that qualify for the deficient zone, in step 2512. If so, the qualifying leads are added to the deficient zone or zones in step 2514 and processing continues to step 2510. If, however, it is determined that no qualifying leads exist in the lead pool for the deficient zone, the manager can input criteria or otherwise use predefined criteria to place filtered leads from a third-party resource or databases 110, 112 or 114 into the leads pool, in step 2516. Thereafter, processing continues to step 2514 and new leads are added to the zone. After a lead is added to a zone, the manager can send an email to the salesperson and/or lock the lead into the zone so that it cannot be removed or deleted. Thus, a manager can ensure that a salesperson is pursuing leads that are of optimum value to generate sales and that the salesperson will incorporate the new and optimized lead in the salesperson's sales plan for a particular zone.

In one exemplary embodiment, the SPS Application includes a software module or the like implementing the method 2500, within the system 100.

The sales management tools of the SPS Application are implemented as a combination of software modules or the like that are accessible through a common interface. These tools help a user organize, implement, and assess the tasks associated with effectively selling a product within a defined territory. For example, the SPS Application assists the user in managing the business relationships with a large number of customers (e.g., 500+) in the user's territory. Furthermore, the user can use the SPS Application to schedule, following through on, and following up on multiple (e.g., 16-20) effective face-to-face customer calls per day and multiple (e.g., ˜30) effective customer contacts per day (e.g., the combination of face-to-face, telephone, email, and other contacts). Further still, the user can use the SPS Application to aid in the planning, presentation, and demonstration of multiple (e.g., at least two) selling ideas for each call. Furthermore, the user can use the SPS Application to track and otherwise manage goals, such as a closing ratio (e.g., 25%+) on new products demonstrated, a quantity (e.g., 10-15) of new or revived accounts per month, etc. Further still, the user can use the SPS Application to readily track or otherwise manage customer profitability and retention.

The above description of specific embodiments has been given by way of example. From the disclosure given, those skilled in the art will not only understand the general inventive concepts and attendant advantages, but will also find apparent various changes and modifications to the structures and methods disclosed. For example, although various exemplary modules have been described herein, different embodiments encompassed by the general inventive concepts could have fewer or more modules than the combinations of modules disclosed herein. As another example, the general inventive concepts are not typically limited to any particular interface between a user and the user's mobile device, and any suitable input mechanism (e.g., voice commands) are within the spirit and scope of the general inventive concepts. As yet another example, although the exemplary embodiments disclosed herein have been primarily directed to use on or with mobile devices, some aspects of the general inventive concepts could be readily extended to a personal computer (PC) or other relatively fixed console computer. It is sought, therefore, to cover all such changes and modifications as fall within the spirit and scope of the general inventive concepts, as described and claimed herein, and equivalents thereof.

1. A system comprising:
a server;
a data store interfaced with the server;
a network; and
a mobile client device for accessing the server over the network,
wherein a user associated with a sales territory uses the mobile client device to decompose the sales territory into a plurality of sales zones,
wherein each of the sales zones is associated with at least one customer, said customer being a current customer or a prospective customer within the sales territory,
wherein each of the sales zones is associated with a different calendar day in a sales cycle, and
wherein the user uses the mobile client device to schedule an activity with each customer in each sales zone on its associated calendar day.

2. The system of claim 1, wherein the user uses the mobile client device to assign a potential value to each customer, and
wherein the potential value is used to determine an amount of time that the user will devote to selling to the customer.

3. The system of claim 2, wherein a first potential value is assigned if the customer has at least one of 100+ employees and $15,000+ annual gross-profit-after-freight potential,
wherein a second potential value is assigned if the customer has at least one of 50-99 employees and $7,500-$14,850 annual gross-profit-after-freight potential,
wherein a third potential value is assigned if the customer has at least one of 25-49 employees and $3,750-$7,350 annual gross-profit-after-freight potential, and
wherein a fourth potential value is assigned if the customer has at least one of 10-24 employees and $1,500-$3,600 annual gross-profit-after-freight potential.

4. The system of claim 1, wherein the user uses the mobile client device to assign a probability value to each customer, said probability value indicating a likelihood of success with the customer.

5. The system of claim 4, wherein a first probability value is assigned if a 90%+ account penetration is expected,
wherein a second probability value is assigned if a 50%+ account penetration is expected,
wherein a third probability value is assigned if a 25%+ account penetration is expected, and
wherein a fourth probability value is assigned if a 10%+ account penetration is expected.

6. The system of claim 1, wherein the user uses the mobile client device to access information relating to each customer in the sales territory.

7. The system of claim 1, wherein the user uses the mobile client device to access information relating to each customer associated with one of the sales zones.

8. The system of claim 1, wherein the user uses the mobile client device to access information relating a specific customer.

9. The system of claim 1, wherein a second user associates an optimized customer to one of the sales zones.

10. The system of claim 1, wherein the user uses the mobile client device to establish a new customer in the system, said new customer being a new current customer or a new prospective customer, and
wherein the new customer is associated with one of the sales zones.

11. The system of claim 1, wherein the user uses the mobile client device to place an order for an item by a customer.

12. The system of claim 1, wherein the user uses the mobile device to initiate synchronization between data stored on the mobile device and data stored in the data store.

13. The system of claim 1, wherein data stored in the mobile device is synchronized with data stored in the data store according to a set schedule.

14. The system of claim 1, wherein data stored in the mobile device is synchronized with data stored in the data store periodically.

15. The system of claim 14, wherein the data stored in the mobile device is synchronized with the data stored in the data store every thirty minutes.

16. The system of claim 1, wherein the network is the Internet.

17. The system of claim 1, wherein the mobile client device communicates with the network over a cellular communications network.

18. The system of claim 1, wherein if communications between the mobile client device and the server are interrupted, data requests from the mobile client device to the server are placed in a queue maintained within the mobile client device until the interruption is resolved.

19. The system of claim 1, wherein the user uses the mobile client device to communicate with the server to request a report,
wherein the server uses data stored in the data store to generate the report, and
wherein the server sends the report in an email to the mobile client device.

20. The system of claim 1, wherein the activity is a visit to a facility of the customer within the sales zone associated with the customer.

21. The system of claim 20, wherein the user uses the mobile client device to activate a navigation function, said navigation function providing driving directions to the facility.

22. The system of claim 1, wherein the user uses the mobile client device to select one or more customers in the same sales zone to be visited on the same calendar day, and
wherein the system calculates a sequence for visiting the customers based on an optimal driving route.

23. The system of claim 1, wherein the activity is one of a telephone call and an email.

24. The system of claim 1, wherein the client mobile device displays a calendar with information on each sales zone and the related customers and activities indicated on the corresponding days of the sales cycle.

25. The system of claim 1, wherein the mobile client device is a tablet computer.

26. The system of claim 1, wherein the sales cycle is twenty days.

27. A system comprising:
a server;
a data store interfaced with the server;
a network;
a mobile client device for accessing the server over the network; and
an application installed on the mobile client device, said application operable to:
decompose a sales territory into a plurality of sales zones;
associate each of the sales zones with at least one customer, said customer being a current customer or a prospective customer within the sales territory;
associate each of the sales zones with a different calendar day in a sales cycle; and
associate an activity with each customer in each of the sales zones on its associated calendar day.

28. The system of claim 27, wherein said application implements a plurality of modules selected from the group comprising: a customers module, a zone setup module, a zone schedule module, a daily sales plan module, an open orders module, a sales history module, an item history module, a past due invoices module, a close activity module, a cloning module, a sync module, a library module, a reports module, and a trade agreements module.

29. The system of claim 27, wherein said application implements a customers module, a zone setup module, a zone schedule module, a daily sales plan module, an open orders module, a price book module, a sales history module, an item history module, a past due invoices module, a close activity module, a cloning module, a sync module, a library module, a reports module, and a trade agreements module.
